(19) United States
(12) Patent Application Publication
(10) Pub. No.: US 2012/0268003 A1
(43) Pub. Date: Oct. 25, 2012

(54) LIGHT EMITTING ELEMENT, LIGHT EMITTING DEVICE, AUTHENTICATION DEVICE, AND ELECTRONIC DEVICE

(75) Inventors: Tetsuji FUJITA, Chino-shi (JP); Hidetoshi YAMAMOTO, Suwa-shi (JP)

(73) Assignee: SEIKO EPSON CORPORATION, Tokyo (JP)

(21) Appl. No.: 13/447,777

(22) Filed: Apr. 16, 2012

(30) Foreign Application Priority Data
Apr. 19, 2011 (JP) 2011-092745

(51) Int. Cl. H05B 33/14

(52) U.S. Cl. 313/504

(57) ABSTRACT

A light emitting element including an anode, a cathode, and at least one light emitting layer that is interposed between the anode and the cathode and is at least involved in light-emission function, wherein at least one of the light emitting layer contains at least one organic compound having a basic skeleton represented by the following formulae (I) to (III) and a compound represented by the following formula (IV).

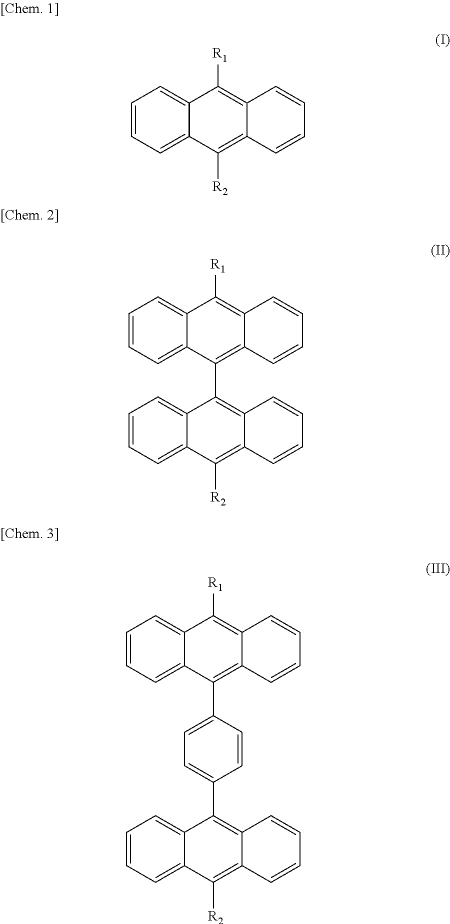

In formulae (I) to (III), R₁ and R₂ are identical to or different from each other independently represent an alkyl group, a substituted or unsubstituted aryl group, an amino group or a heterocyclic group,

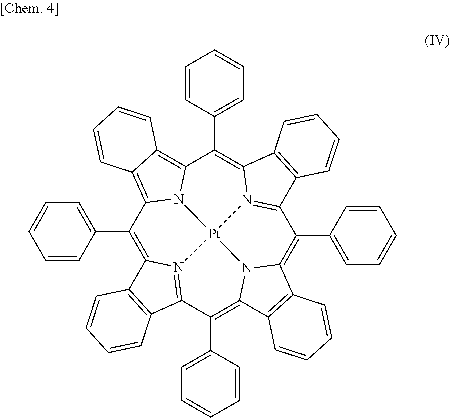

Wherein formula (IV) represents Pt (II) tetraphenyl-tetrabenzo-porphyrin.

### TECHNICAL FIELD

The present invention relates to a light emitting element, a light emitting device, an authentication device and an electronic device.

### RELATED ART

An organic electroluminescence element (so-called organic EL element) is a light emitting element having a structure in which a light emitting organic layer including at least one layer is interposed between an anode and a cathode. In such a light emitting element, when an electric field is applied between the cathode and the anode, electrons were injected from the cathode to the light emitting layer and, at the same time, holes are injected from the anode, and the electrons and the holes are then recombined in the light emitting layer to produce excitons. When these excitons return to a ground state, light corresponding to the energy is emitted.

The light emitting element is known to emit light of a long wavelength region greater than 700 nm a near-infrared ray (for example, see Patent Documents 1 and 2).

For example, light emitting elements disclosed in Patent Documents 1 and 2 use a material in which, with respect to functional groups in the molecules, amine as an electron donor and a nitrile group as an electron acceptor are present together, as a dopant of a light emitting layer, thereby lengthening a light emitting wavelength.

However, in the related art, elements that exhibit high efficiency and long lifespan and emit a near-infrared region light could not be realized.

Also, realization of light emitting elements that emit a near-infrared region of light and exhibit high efficiency and long lifespan is required as a light source for bio-authentication to authenticate a person using bio-information such as veins and fingerprints.

### PRIOR ART DOCUMENTS

### Patent Documents

[Patent Document 1] JP-A-2000-091903

[Patent Document 2] JP-A-2001-110570

### SUMMARY OF INVENTION

### Problems to be Solved by the Present Invention

An object of the invention is to provide a light emitting element that emits a near-infrared region light and exhibits high efficiency and long lifespan, a light emitting device, an authentication device and an electronic device including the light emitting element.

The above-described object is realized by at least of the following application examples.

### Means for Solving the Problems

### Application Example 1

A light emitting element according to the application example 1 including: an anode; a cathode; and a light emitting layer that is interposed between the anode and the cathode and emits light through electric connection between the anode and the cathode, wherein the light-emitting layer contains a light-emitting material and a host material, the host material is at least one selected from organic substances having a basic skeleton represented by formulae (I) to (III), and the light-emitting material is a compound represented by formula (IV),

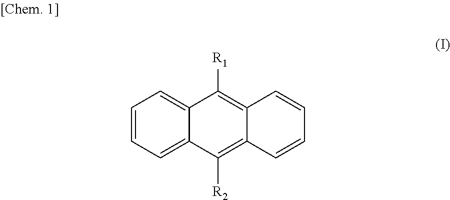

In formula (I), R₁ and R₂ are identical to or different from each other independently represent an alkyl group, a substituted or unsubstituted aryl group, an amino group or a heterocyclic group,

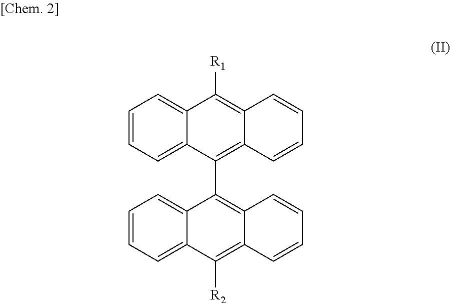

In formula (II), R₁ and R₂ are identical to or different from each other independently represent an alkyl group, a substituted or unsubstituted aryl group, an amino group or a heterocyclic group,

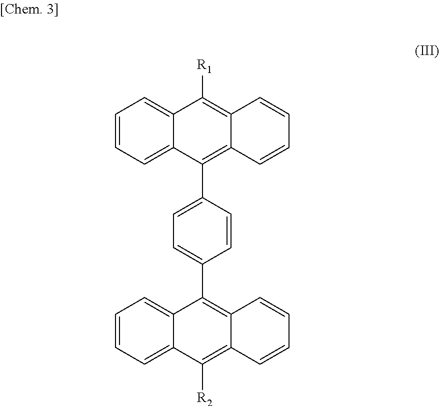

In formula (III), R₁ and R₂ are identical to or different from each other independently represent an alkyl group, a substituted or unsubstituted aryl group, an amino group or a heterocyclic group,

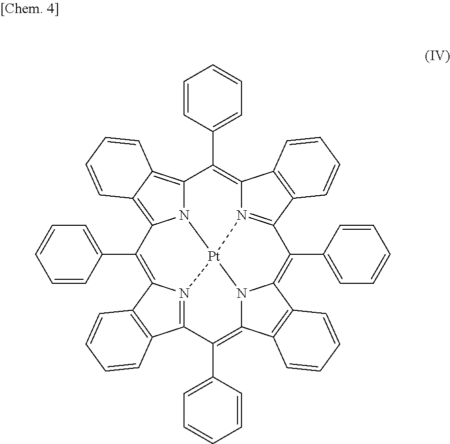

formula (IV) represents Pt (II) tetraphenyl-tetrabenzo-porphyrin.

According to the light emitting element having this configuration, the light emitting element uses the compound represented by the following formula (IV) as a light emitting material, thus emits light of a wavelength region (near-infrared region) of 700 nm or longer.

Also, since the light emitting element uses anthracene-based materials represented by the above-described formulae (I) to (III) as host materials, the light emitting element can efficiently transfer energy from the host material to the light-emitting material. For this reason, the light emitting element can exhibit superior luminescent efficiency.

Also, an anthracene-based material exhibits superior stability (resistance) to electrons and holes. In terms of this point, the lifespan of the light emitting layer and the light emitting element can be lengthened.

### Application Example 2

A light emitting element according to the application example 2 including: an anode; a cathode; and a light emitting layer that emits light through electric connection between the anode and the cathode, the light-emitting layer contains a host material and a dopant, the host material is at least one selected from organic substances having a basic skeleton represented by formulae (I) to (III), and the dopant is a compound represented by formula (IV).

According to this Application Example, by using the compound (IV) as a light emitting dopant and at least one of compounds (I) to (III) as a host material for an EL element, an element with high efficiency and long lifespan can be obtained.

### Application Example 3

In the light emitting element of the aforementioned Application Examples, the light emitting element is provided between the cathode and the light emitting layer such that the light emitting element contacts the light emitting layer, and includes an electron transfer layer having electron transfer property, the electron transfer layer contains a compound having azaindolizine skeletons and anthracene skeletons in the molecule as an electron transfer material.

According to the light emitting element having such a configuration, by using a compound having azaindolizine skeletons and anthracene skeletons in the molecule as an electron transfer material for an electron transfer layer that contacts the light emitting layer, electrons can be efficiently transferred from the electron transfer layer to the light emitting layer. For this reason, the light emitting element can exhibit superior luminescent efficiency.

Also, since electrons can be efficiently transferred from the electron transfer layer to the light emitting layer, the driving voltage of the light emitting element can be reduced and lifespan of the light emitting element can be lengthened.

Also, the compound having azaindolizine skeletons and anthracene skeletons in the molecule exhibits superior stability (resistance) to electrons and holes. For this reason, lifespan of the light emitting element can be lengthened.

### Application Example 4

In the light emitting element of the Application Example, the respective numbers of azaindolizine skeletons and anthracene skeletons contained in one molecule of the electron transfer material are preferably one or two.

As a result, the electron transfer layer can exhibit superior electron transfer property and electron injection property.

In the light emitting element of the invention, the light emitting layer preferably contains a host material that retains a dopant.

As a result, the host material produces excitons by recombining holes with electrons, and moves the energy of the excitons to the light emitting material, thereby exciting the light emitting material. For this reason, luminescent efficiency of the light emitting element can be improved.

### Application Example 5

In the light emitting element of the Application Example, the host material preferably contains an acene-based material.

As a result, the light emitting element efficiently transfers electrons from the anthracene skeleton part of the electron transfer material in the electron transfer layer to the acene-based material in the light emitting layer.

### Application Example 6

In the light emitting element of the Application Example, the acene-based material is preferably an anthracene-based material.

As a result, the light emitting element efficiently transfers electrons from the anthracene skeleton part of the electron transfer material in the electron transfer layer to the anthracene-based material of the light emitting layer.

### Application Example 7

In the light emitting element of the Application Example, the acene-based material is preferably a tetracene-based material.

As a result, the light emitting element can efficiently transfer electrons from the anthracene skeleton part of the electron transfer material in the electron transfer layer to the tetracene-based material of the light emitting layer.

### Application Example 8

In the light emitting element of the Application Example, the acene-based material is preferably composed of carbon atoms and hydrogen atoms.

As a result, it is possible to prevent undesired interaction between the host material and the light emitting material. For this reason, luminescent efficiency of the light emitting element can be improved. Also, resistance of the host material to electric potential and holes can be improved. For this reason, the lifespan of the light emitting element can be lengthened.

### Application Example 9

In the light emitting element of the Application Example, the host material preferably contains a quinolinolate-based metal complex.

As a result, the quinolinolate-based metal complex produces excitons by recombining holes with electrons, and moves the energy of the excitons to the light emitting material, thereby exciting the light emitting material. Also, by using slow carrier mobility of quinolinolate-based metal complex, the balance between electrons and holes in the light emitting layer can be controlled and lifespan of the light emitting element can be lengthened.

### Application Example 10

In the light emitting element of the Application Example, the content of the host material is 80 to 99% by mass.

According to the present Application Example, by adjusting the content of the host material to 80 to 99% by mass, an EL element with high efficiency and long lifespan can be obtained.

### Application Example 11

In the light emitting element of the Application Example, the light emitting element includes a hole injection transfer layer provided between the anode and the light emitting layer.

According to the present Application Example, by adopting a material layer having superior hole injection property, an element with a low voltage, high efficiency and long lifespan can be obtained.

### Application Example 12

In the light emitting element of the Application Example, the light emitting element includes an electron injection transfer layer provided between the cathode and the light emitting layer.

According to the present Application Example, by adopting a material layer having superior electron injection property, an element with a low voltage, high efficiency and long lifespan can be obtained.

### Application Example 13

A light emitting device of the present Application Example includes the light emitting element described in any one of the Application Examples.

Such a light emitting device can emit a near-infrared region light. Also, the light emitting device includes a light emitting element with high efficiency and long lifespan, thus exhibiting reliability.

### Application Example 14

The authentication device of the present Application Example includes the light emitting element described in any one of Application Examples.

Such an authentication device can perform bio-authentication using near-infrared light. Also, the authentication device includes a light emitting element with high efficiency and long lifespan, thus exhibiting reliability.

### Application Example 15

The electronic device of the present Application Example includes the light emitting element described in any one of Application Examples.

Such an electronic device includes a light emitting element with high efficiency and long lifespan, thus exhibiting reliability.

### BRIEF DESCRIPTION OF DRAWINGS

FIG. 1 is a vertical cross-sectional view schematically illustrating a light emitting element according to one embodiment of the invention.

FIG. 2 is a vertical cross-sectional view illustrating an embodiment of display device using the light emitting device of the invention.

FIG. 3 is a view illustrating an embodiment of an authentication device of the invention.

FIG. 4 is a perspective view illustrating the configuration of a mobile-type (or note-type) personal computer using the electronic device of the invention as an embodiment.

FIG. 5 is a view illustrating light emitting spectra of a light emitting element in Example 1-1 of the invention.

FIG. 6 is a view illustrating light emitting spectra of a light emitting element in Comparative Example 1-1 of the invention.

### BEST MODES FOR CARRYING OUT THE PRESENT INVENTION

Hereinafter, preferred embodiments of the light emitting element, the light emitting device, the authentication device and the electronic device according to the invention will be described with reference to the attached drawings.

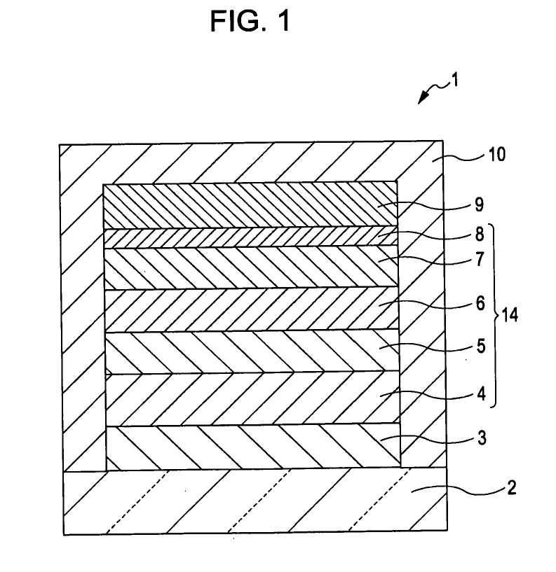

FIG. 1 is a sectional view schematically illustrating a light emitting element according to one embodiment of the invention. In addition, for better understanding, the upper part and the lower part of FIG. 1 are represented by “upper” and “lower”, respectively.

The light emitting element (electroluminescence element) 1 shown in FIG. 1 includes an anode 3, a hole injection layer 4, a hole transfer layer 5, a light emitting layer 6, an electron transfer layer 7, an electron injection layer 8 and a cathode 9 which are laminated in this order.

That is, in the light emitting element 1, a laminate 14 that includes the hole injection layer 4, the hole transfer layer 5, the light emitting layer 6, the electron transfer layer 7 and the electron injection layer 8 which are laminated from the anode 3 to the cathode 9 in this order is interposed between the anode 3 and the cathode 9.

In addition, the entirety of the light emitting element 1 is mounted on a substrate 2 and is sealed with a sealing member 10.

In such a light emitting element 1, when a driving voltage is applied to the anode 3 and the cathode 9, electrons are supplied (injected) from the cathode 9 to the light emitting layer 6 and, at the same time, holes are supplied (injected) from the anode 3 thereto. In addition, in the light emitting layer 6, holes and electrons are recombined together, excitons are produced by energy emitted during the recombination and energy (fluorescence or phosphorescence) is emitted when the excitons return to a ground state. As a result, the light emitting element 1 emits light.

In particular, as mentioned above, the light emitting element 1 emits a near-infrared region of light using a Pt(II) tetraphenyl-tetrabenzo-porphyrin (Frontier Science INC.) as a light emitting material of the light emitting layer 6. In addition, in this specification, “near-infrared region” refers to a wavelength range of 700 nm to 1500 nm.

The substrate 2 supports the anode 3. The light emitting element 1 according to this embodiment has a configuration (bottom emission-type) in which light is emitted from the side of the substrate 2, the substrate 2 and the anode 3 are each substantially transparent (colorless transparent, colored transparent, or semi-transparent).

Examples of a material constituting the substrate 2 include resin materials such as polyethylene terephthalate, polyethylene naphthalate, polypropylene, cycloolefin polymers, polyamide, polyether sulfone, polymethyl methacrylate, polycarbonate, and polyarylate, glass materials such as quartz glass and soda glass. This material may be used alone or in combination of two or more types.

The average thickness of the substrate 2 is not particularly limited and is preferably about 0.1 to about 30 mm, more preferably, about 0.1 to about 10 mm.

In addition, when the light emitting element 1 has a configuration (top emission-type) in which light is emitted from the side opposite to the substrate 2, the substrate 2 may be either a transparent substrate or a non-transparent substrate.

Examples of the non-transparent substrate include substrates composed of ceramic materials such as alumina, metals substrates such as stainless steel provided at the surface thereof with oxide films (insulating films), substrates composed of resin materials and the like.

Also, in the light emitting element 1, the distance between the anode 3 and the cathode 9 (that is, average thickness of laminate 14) is preferably 150 to 300 nm, more preferably, 150 to 250 nm. As a result, the driving voltage of the light emitting element 1 can be simply and accurately adjusted within a practical range.

Hereinafter, elements constituting the light emitting element 1 are described in order.

Anode

The anode 3 is an electrode in which holes are injected to the hole transfer layer 5 through the hole injection layer 4 described below.

A material constituting the anode 3 is a preferably a material that has a high work function and superior conductivity.

Examples of the material constituting the anode 3 include indium tin oxide (ITO), indium zinc oxide (IZO), In₃O₃, SnO₂, Sb-containing SnO₂, Al-containing oxides such as ZnO, Au, Pt, Ag, Cu or alloys containing the same and the like. The material may be used alone or in combination of two or more types.

In particular, the anode 3 is preferably composed of ITO. ITO is a material that has transparency, high work function and high conductivity. ITO enables holes to be efficiently injected from the anode 3 to the hole injection layer 4.

Also, the surface of the side of the hole injection layer 4 of the anode 3 (the upper surface of FIG. 1) is preferably treated with plasma. As a result, chemical and physical stability of the surface at which the anode 3 contacts the hole injection layer 4 can be improved. As a result, a hole injection property from the anode 3 to the hole injection layer 4 can be improved. In addition, such plasma treatment will be described in detail in the following production method of the light emitting element 1.

The average thickness of the anode 3 is not particularly limited and is preferably about 10 to about 200 nm, more preferably about 50 to about 150 nm.

Cathode

Meanwhile, the cathode 9 is an electrode that injects electrons to the electron transfer layer 7 through the electron injection layer 8 described below. The material constituting the cathode 9 is preferably a material that has a low work function.

Examples of a material constituting the cathode 9 include Li, Mg, Ca, Sr, La, Ce, Er, Eu, Sc, Y, Yb, Ag, Cu, Al, Cs, Rb or alloys containing the same and the like. The material may be used alone or in combination of two or more types (for example, as a laminate including a plurality of layers, a mixed layer including a plurality of types).

In particular, when an alloy is used as the material constituting the cathode 9, use of alloys including stable metal elements such as Ag, Al and Cu, specifically, alloys such as MgAg, AlLi and CuLi is preferred. By using this alloy as a constituent material of the cathode 9, electron injection efficiency and stability of the cathode 9 can be improved.

The average thickness of the cathode 9 is not particularly limited and is preferably about 100 to about 10000 nm, more preferably about 100 to about 500 nm.

In addition, since the light emitting element 1 of this embodiment is a bottom emission-type, light transmittance is particularly not required for the cathode 9. Also, when the light emitting element 1 is a top emission-type, light should be transmitted from the cathode 9. Accordingly, the average thickness of the cathode 9 preferably has about 1 to about 50 nm.

Hole Injection Layer

The hole injection layer 4 improves injection efficiency of holes from the anode 3 (that is, has a hole injection property).

As such, by mounting the hole injection layer 4 between the anode 3 and the hole transfer layer 5 described below, injection property of holes from the anode 3 can be improved, and, as a result, luminescent efficiency of the light emitting element 1 can be thus increased.

The hole injection layer 4 contains a material that has a hole injection property (that is, hole injecting material).

Examples of the hole injecting material contained in the hole injection layer 4 include, but are not particularly limited to, copper phthalocyanine or, 4,4′,4″-tris(N,N-phenyl-3-methylphenylamino)triphenyl amine (m-MTDATA), N,N′-bis-(4-diphenylamino-phenyl)-N,N′-diphenyl-biphenyl-4-4′-diamine, tetra-p-biphenylylbenzidine and the like.

Of these, an amine-based material is preferred as the hole injecting material contained in the hole injection layer 4, in terms of superior hole injection property and hole transfer property, and a diaminobenzene derivative, a benzidine derivative (material having a benzidine skeleton), and a triamine-based compound and a tetraamine-based compound that have both a “diaminobenzene” unit and a “benzidine” unit in the molecule are more preferred.

The average thickness of the hole injection layer 4 is not particularly limited and is preferably about 5 to about 90 nm, more preferably about 10 to about 70 nm.

In addition, the hole injection layer 4 may be omitted depending on the constituent material of the anode 3 and the hole transfer layer 5.

Hole Transfer Layer

The hole transfer layer 5 is capable of transferring holes injected through the hole injection layer 4 from the anode 3 to the light emitting layer 6 (that is, has a hole transfer property).

The hole transfer layer 5 contains a material having a hole transfer property (that is, hole-transferring material).

As the hole-transferring materials contained in the hole transfer layer 5, various p-type high-molecular materials or various p-type low-molecular materials may be used singly or in combination thereof, and examples thereof include tetraarylbenzidine derivatives such as N,N′-di(1-naphthyl)-N,N′-diphenyl-1,1′-diphenyl-4,4′-diamine (NPD), N,N′-diphenyl-N,N′-bis(3-methylphenyl)-1,1′-diphenyl-4,4′-diamine, tetra-p-biphenylylbendizine (TPD), tetraaryldiaminofluorene compounds and derivatives thereof (amine-based compounds) and the like. This material may be used alone or in combination of two or more types.

Of these, as the hole-transferring material contained in the hole transfer layer 5, an amine-based material is preferred in terms of a superior hole injection property and a hole transfer property, and a benzidine derivative (material having a benzidine skeleton) is more preferred.

The average thickness of the hole transfer layer 5 is not particularly limited and is preferably about 5 to about 90 nm, more preferably about 10 to about 70 nm.

Light Emitting Layer

The light emitting layer 6 emits light when electric connection is applied between the anode 3 and the cathode 9.

Such a light emitting layer 6 includes a light emitting material.

In particular, the light emitting layer 6, as a light emitting material, contains a compound represented by the following formula (IV) (hereinafter, simply referred to as a “Pt-TPTBP”).

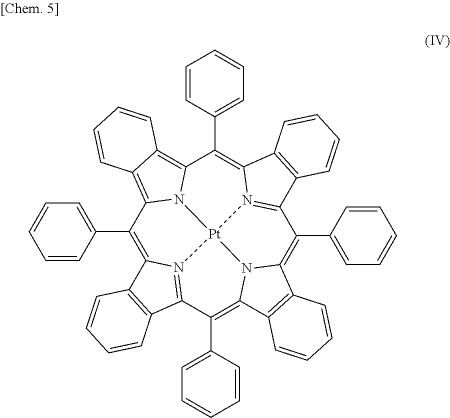

The light emitting layer 6 containing the Pt-TPTBP (specifically, Pt(II) Tetraphenyl tetrabenzo porphyrin) can emit light with a wavelength region (near-infrared region) of 700 nm or more. In particular, emission of light having a peak at about 770 nm can be obtained.

In addition, the light emitting layer 6 may contain a light-emitting material in addition to the aforementioned light-emitting materials (various fluorescence materials, various phosphorescence materials).

Also, as the constituent material of the light emitting layer 6, in addition to the aforementioned light emitting material, a host material in which the light emitting material is added (contained) as a guest material (dopant) is used. This host material produces excitons by recombining holes with electrons, and moves (Foerster movement or Dexter movement) the energy of the excitons to the light emitting material, thereby exciting the light emitting material. For this reason, luminescent efficiency of the light emitting element 1 can be improved. Such a host material may be for example used by doping a light emitting material which is a guest material as a dopant into a host material.

Any host material may be used without particular limitation so long as it exerts the aforementioned functions to the light emitting material and examples thereof include distyrylarylene derivatives, naphthacene derivatives such as compounds represented by the following formula (7), anthracene derivatives such as 2-t-butyl-9,10-di(2-naphthyl)anthracene (TBADN), perylene derivatives, distyrylbenzene derivatives, distyrylamine derivatives, bis(2-methyl-8-quinolinorate)(p-phenylphenolate)aluminum (BAlq), quinolinolate-based metal complexes such as tris(8-quinolinorate)aluminum complexes (Alq₃), triarylamine derivatives such as triphenyl amine tetramers, oxadiazole derivatives, rubrene and derivatives thereof, thyrol derivatives, dicarbazole derivatives, oligothiophene derivatives, benzopyrane derivatives, triazole derivatives, benzoxazole derivatives, benzothiazole derivatives, quinoline derivatives, 4,4′-bis(2,2′-diphenyl vinyl)biphenyl (DPVBi), carbazole derivatives such as 3-phenyl-4-(1′-naphthyl)-5-phenylcarbazole and 4,4′-N,N′-dicarbazole biphenyl (CBP) and the like. This material may be used alone or in combination of two or more types.

Of these, an acene-based material is used as a host material. When the host material of the light emitting layer 6 contains an acene-based material, it can efficiently transfer electrons from the anthracene skeleton part of the electron transfer material in the electron transfer layer 7 to the acene-based material in the light emitting layer 6.

The acene-based material has low undesired interaction with the aforementioned light emitting material. Also, when an acene-based material (in particular, anthracene-based material, tetracene-based material) is used as a host material, energy can be efficiently performed from the host material to the light emitting material. The reason for this is that (a) generation of a singlet excited state of light emitting material is possible through energy movement from a triplet excited state of acene-based material, (b) overlap between a it electron cloud of the acene-based material and an electron cloud of the light emitting material increases, and (c) overlap between a fluorescence spectrum of the acene-based material and an absorption spectrum of the light emitting material increases.

For this reason, when an acene-based material is used as a host material, luminescent efficiency of the light emitting element 1 can be improved.

Also, the acene-based material exhibits superior resistance to electrons and holes. Also, the acene-based material exhibits superior thermal stability. For this reason, the light emitting element 1 contributes to realization of long lifespan. Also, since the acene-based material exhibits superior thermal stability, when a light emitting layer is formed using a vapor film formation method, decomposition of the host material by heat during film formation can be prevented. For this reason, a light emitting layer with superior film qualities is formed, as a result, luminescent efficiency of the light emitting element 1 can be improved and realization of long lifespan can be facilitated.

Also, since the acene-based material cannot self-emit light, it can prevent the host material from having an adverse effect on the light emitting spectrum of the light emitting element 1.

Any acene-based material may be used without particular limitation so long as it has an acene skeleton and exerts the aforementioned effects and examples thereof include naphthalene derivatives, anthracene derivatives, naphthacene derivatives (tetracene derivatives), pentacene derivatives, hexacene derivatives, heptacene derivatives and the like. This material may be used alone or in combination of two or more types. The acene-based material is preferably an anthracene derivative (anthracene-based material) or a tetracene derivative (tetracene-based material).

As a result, electrons can be efficiently transferred from the anthracene skeleton part of the electron transfer material in the electron transfer layer 7 to the anthracene-based material or tetracene-based material in the light emitting layer 6.

Any tetracene-based material may be used without particular limitation so long as it has at least one tetracene skeleton in one molecule and exerts the aforementioned functions as a host material and, for example, is preferably a compound represented by the following formula IRH-1, more preferably, a compound represented by the following formula IRH-2, even more preferably, a compound represented by the following formula IRH-3.

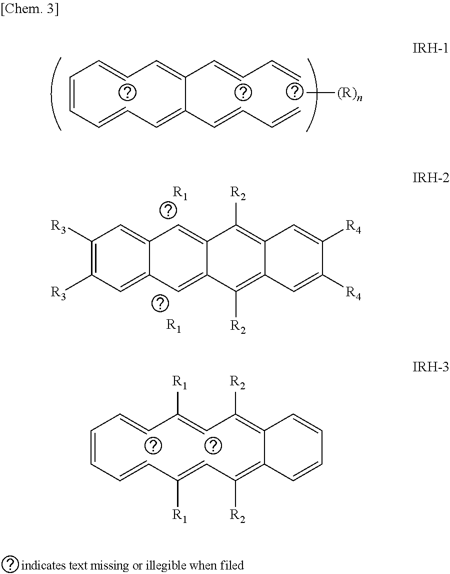

[In formula IRH-1, n represents a natural number of 1 to 12, R represents a substituent group or a functional group and each independently represents a hydrogen atom, an alkyl group, or an aryl group or an arylamino group which may have a substituent group. Also, in formulae IRH-2 and IRH-3, R₁ to R₄ each independently represent a hydrogen atom, an alkyl group, or an aryl group or an arylamino group which may have a substituent group. Also, R₁ to R₄ may be identical or different.]

Also, the tetracene-based material is preferably composed of carbon atoms and hydrogen atoms. As a result, it is possible to prevent occurrence of undesired interaction between the host material and the light emitting material. For this reason, it is possible to improve luminescent efficiency of the light emitting element 1. Also, it is possible to improve resistance of host material to electric potential and holes. For this reason, it is possible to realize long lifespan of the light emitting element 1.

Specifically, as the tetracene-based material, for example, compounds represented by the following formulae H1-1 to H1-11, and compounds represented by the following formulae H1-12 to H1-27 are preferably used.

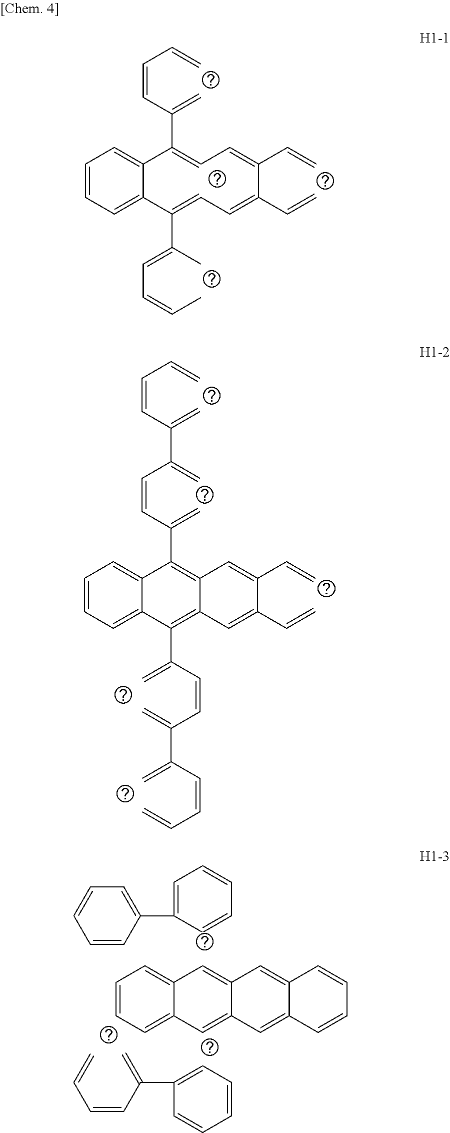

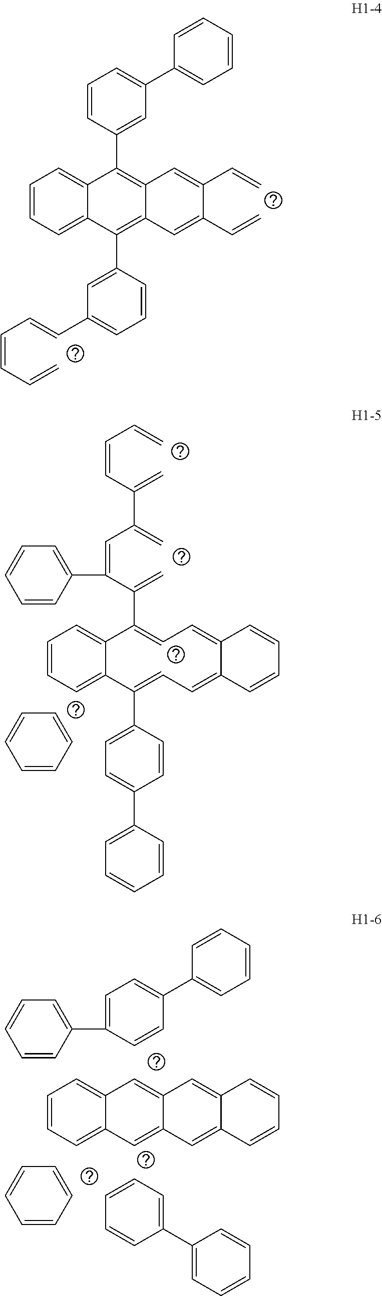

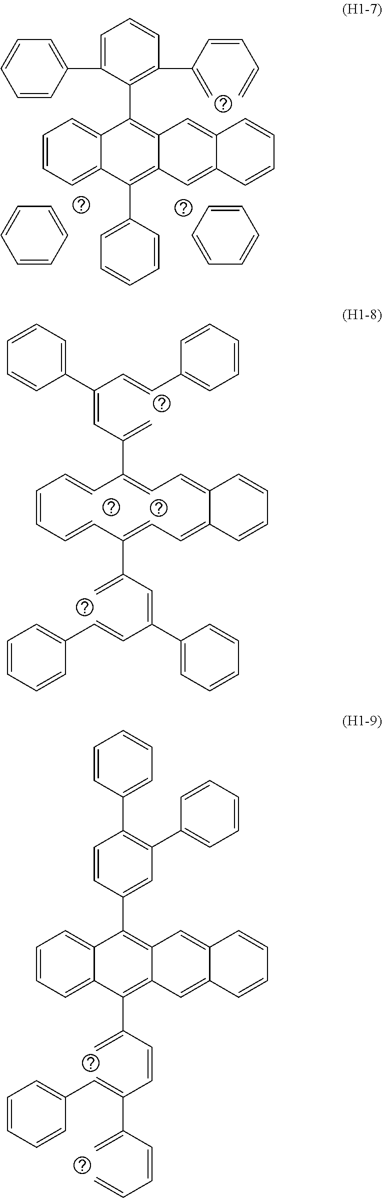

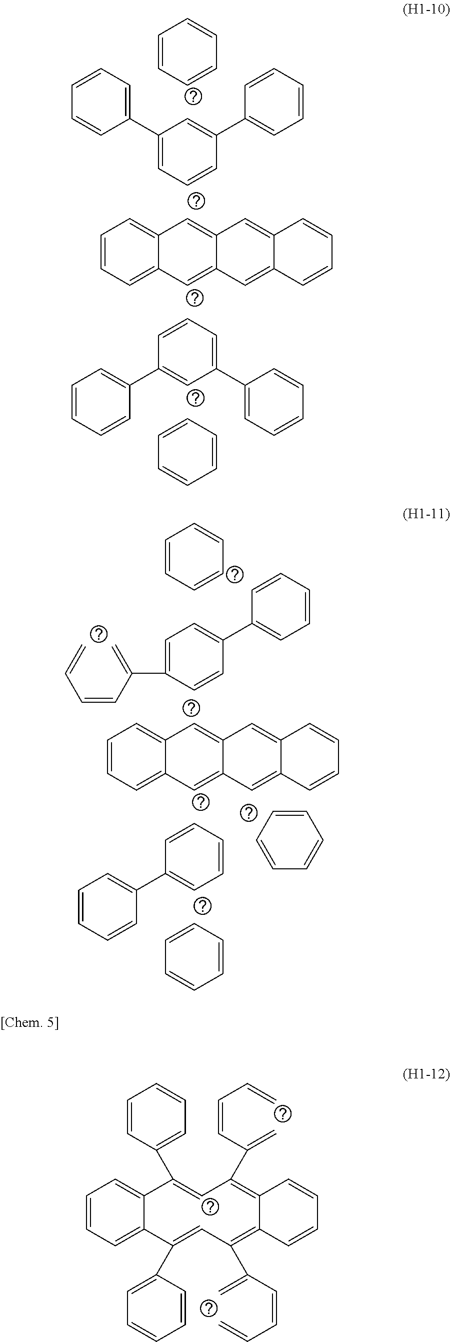

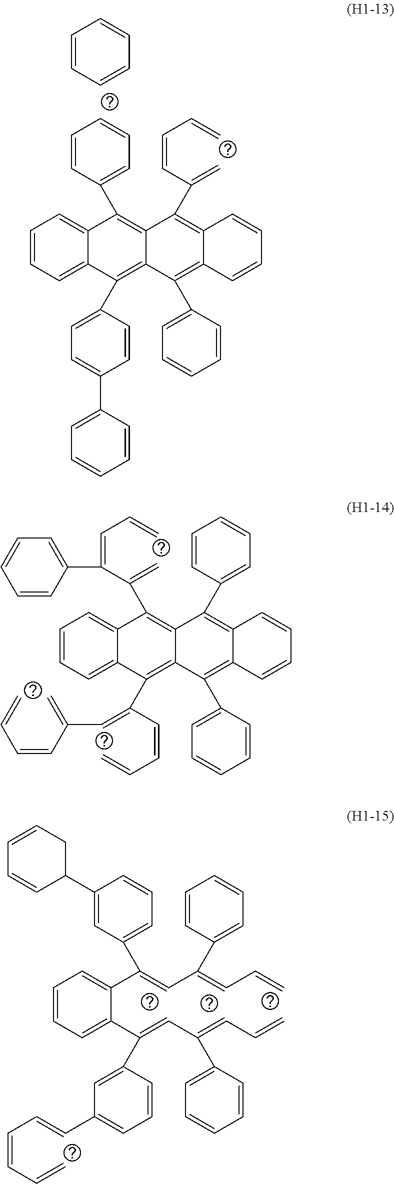

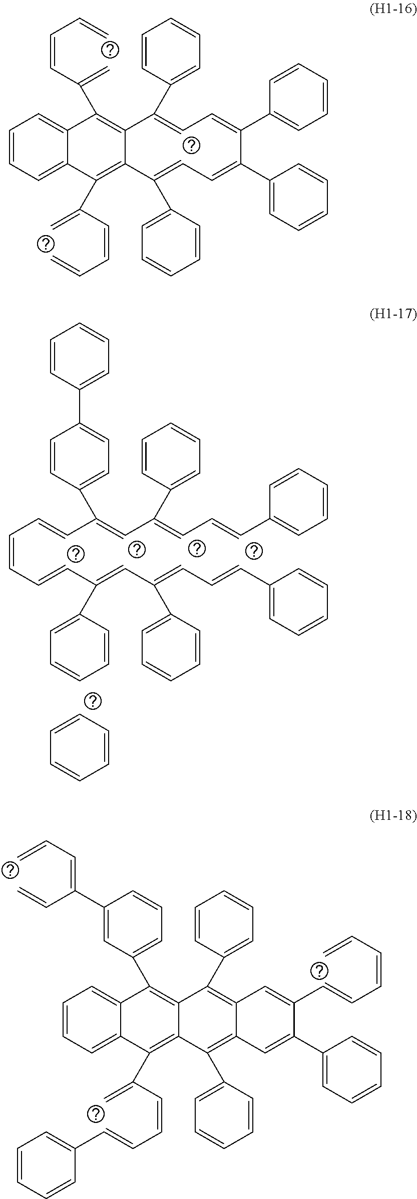

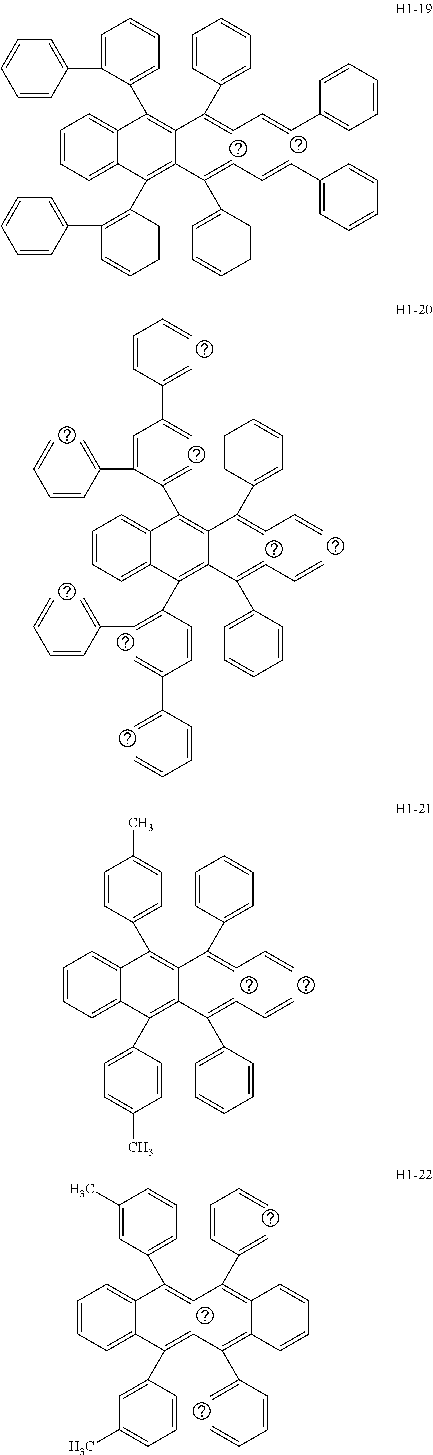

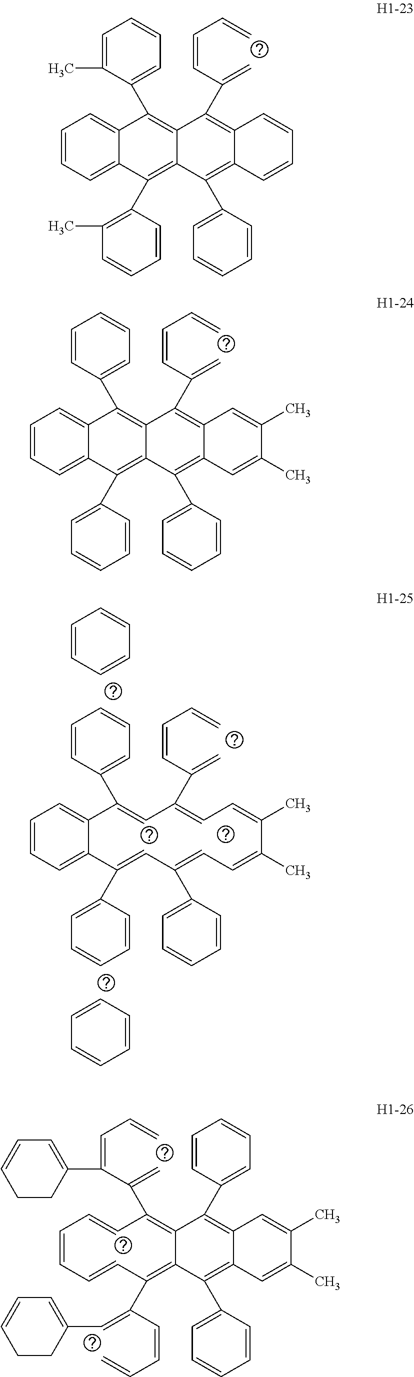

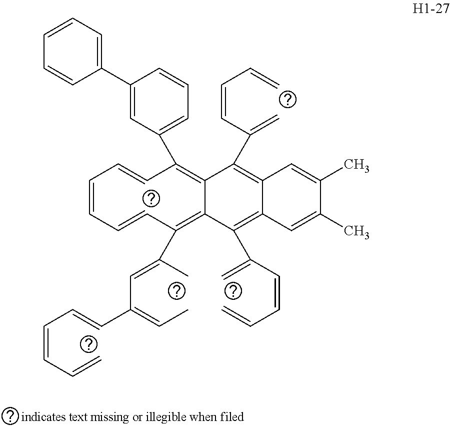

Also, any anthracene-based material may be used without particular limitation so long as it has at least one anthracene skeleton in one molecule and exerts the aforementioned functions as a host material and, for example, is preferably a compound or a derivative thereof represented by the following formula IRH-4, more preferably, compounds represented by the following formulae IRH-5 to IRH-8. As a result, light-emitting efficiency of the light emitting element can be further increased and the lifespan of the light emitting element 1 can be lengthened.

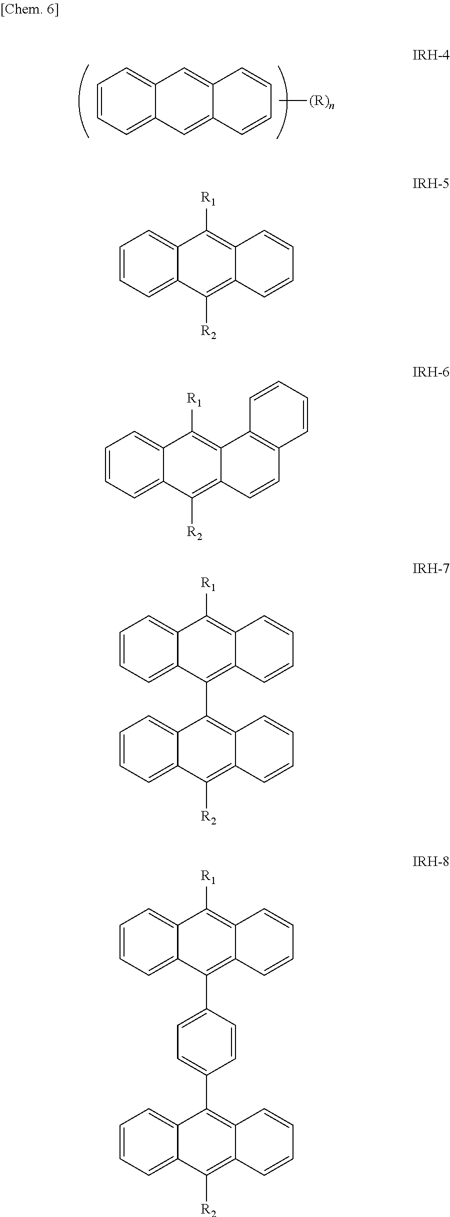

[In formula IRH-4, n represents a natural number of 1 to 10, R represents each independently represents a hydrogen atom, an alkyl group, or an aryl group or an arylamino group which may have a substituent group. Also, in formulae IRH-5 to IRH-8, R₁ and R₂ each independently represent a hydrogen atom, an alkyl group, or an aryl group or an arylamino group which may have a substituent group. Also, R₁ and R₂ may be identical or different.]

Also, the anthracene-based material is preferably composed of carbon atoms and hydrogen atoms. As a result, it is possible to prevent occurrence of undesired interaction between the host material and the light emitting material. For this reason, it is possible to improve luminescent efficiency of the light emitting element 1. Also, it is possible to improve resistance of host material to electric potential and holes. For this reason, it is possible to realize long lifespan of the light emitting element 1.

Specifically, the anthracene-based material is for example preferably compounds represented by the following formulae H2-1 to H2-80.

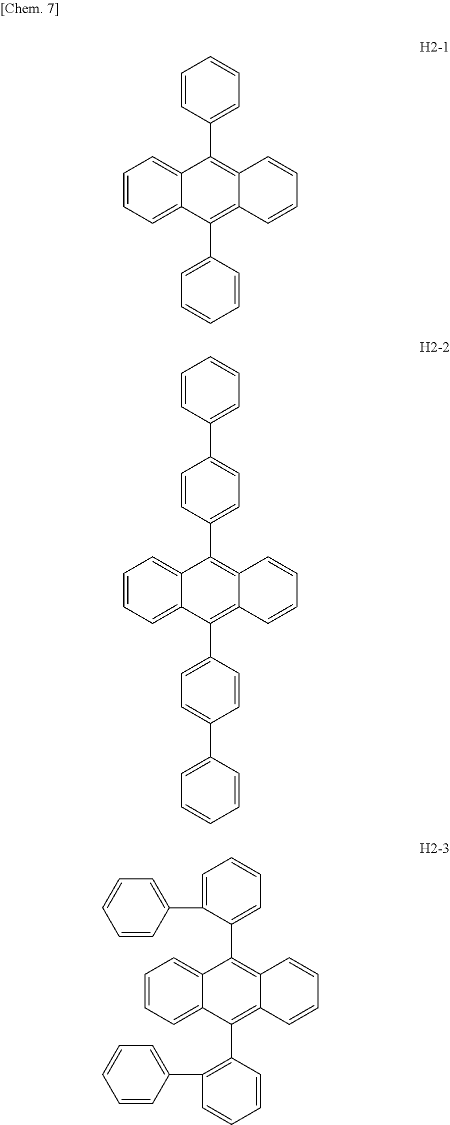

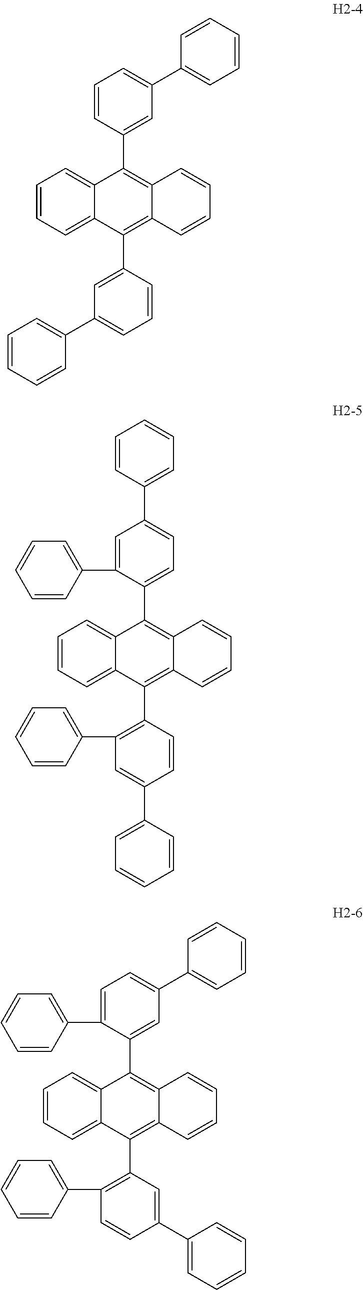

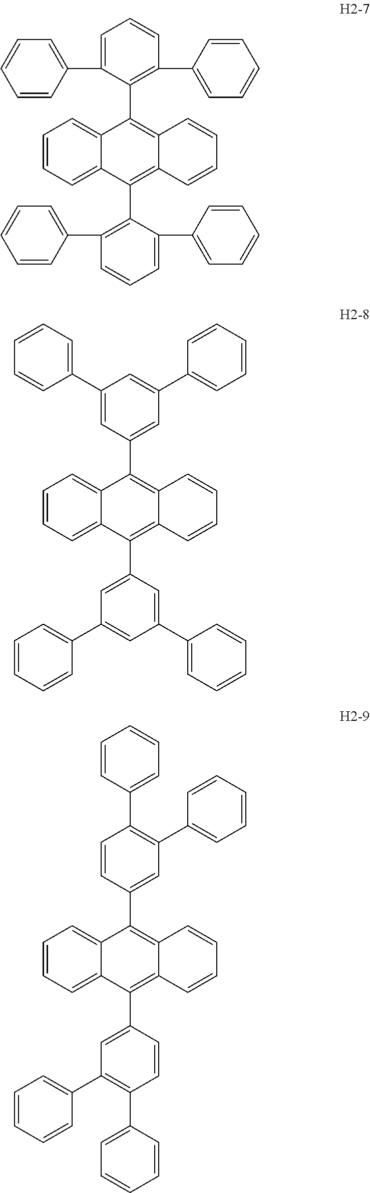

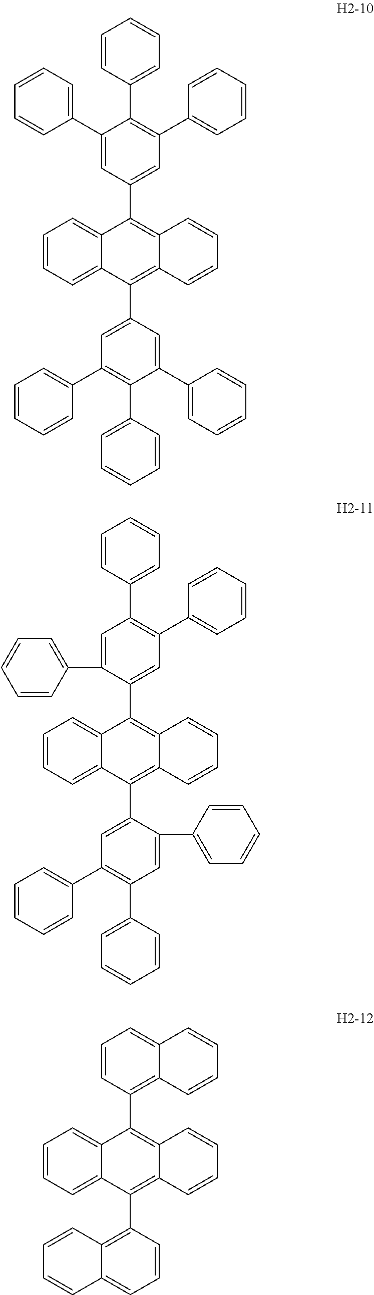

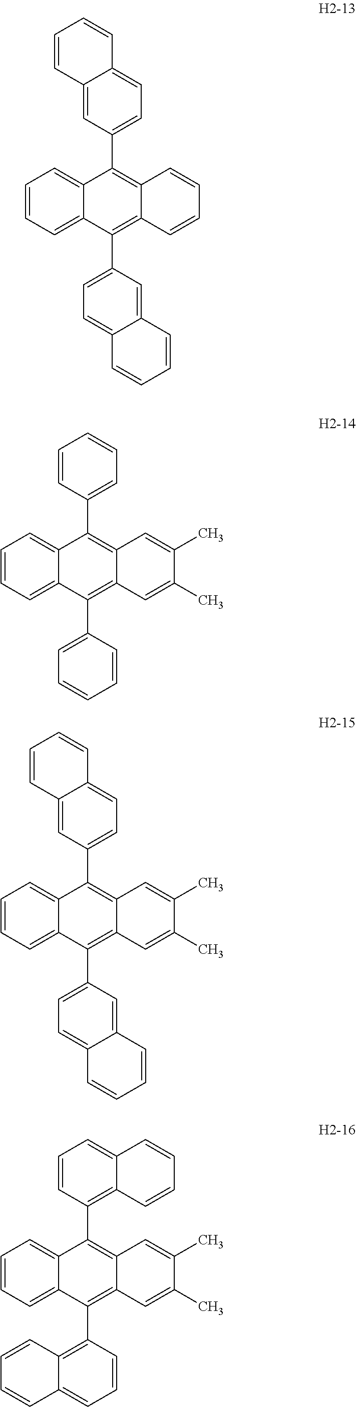

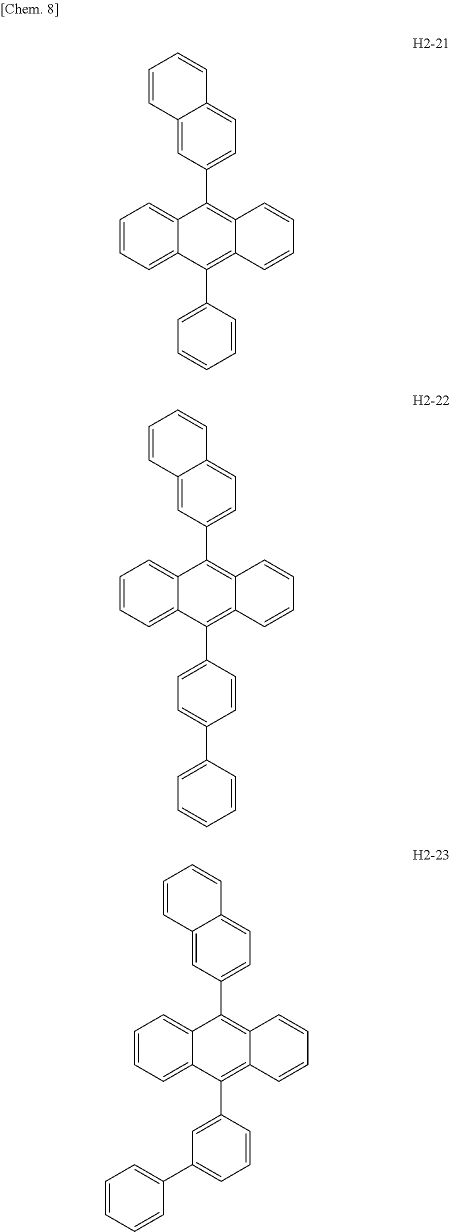

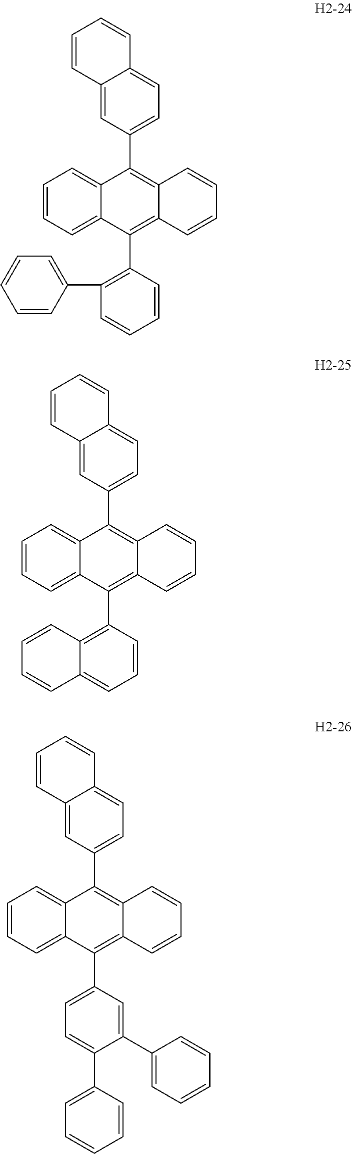

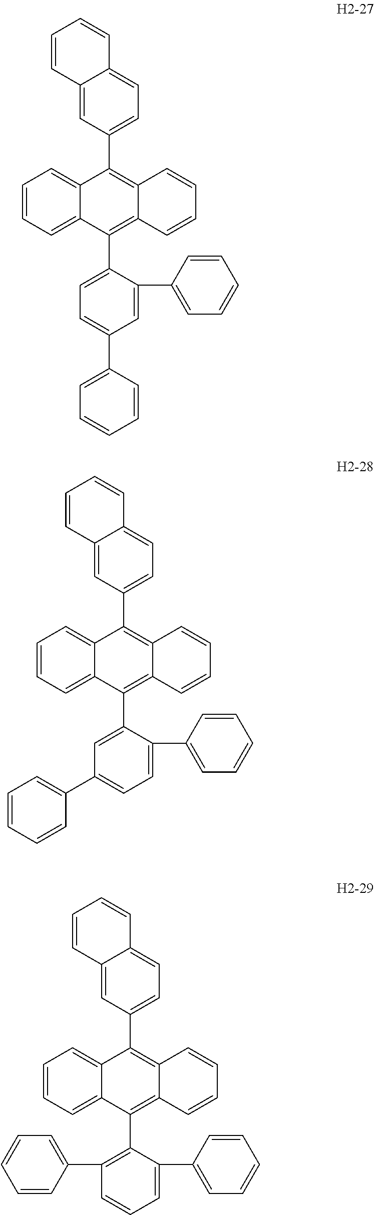

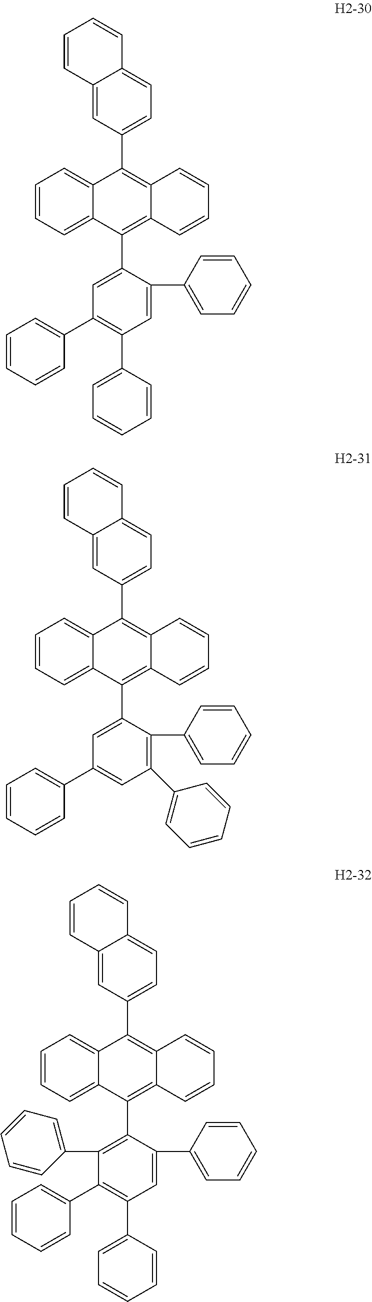

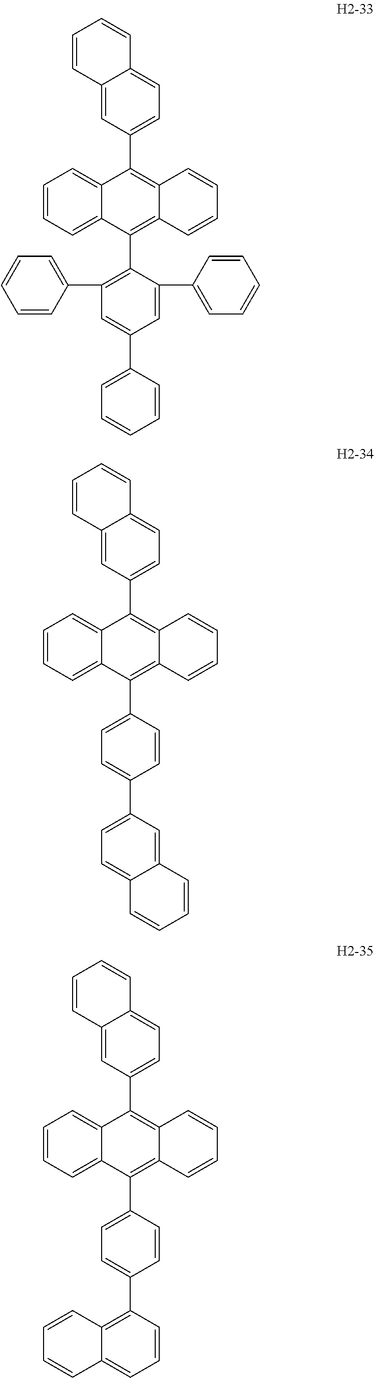

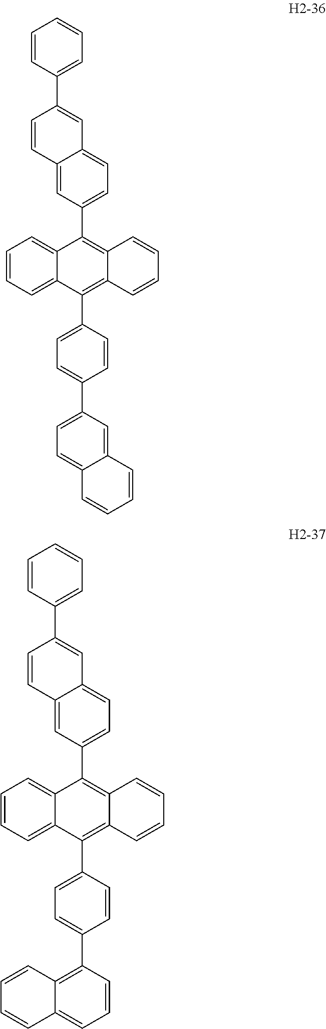

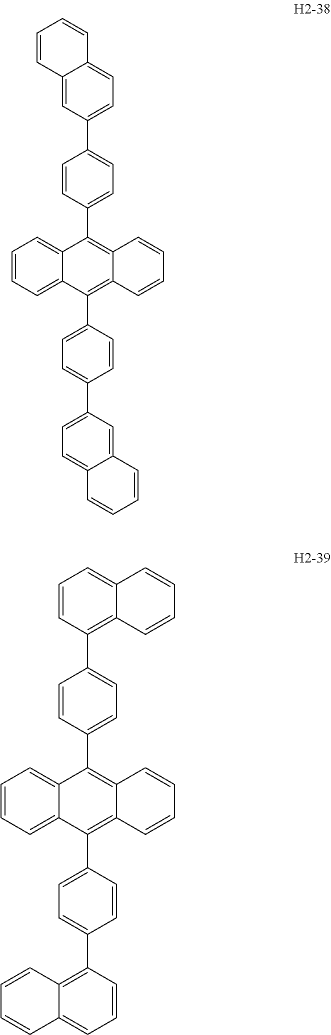

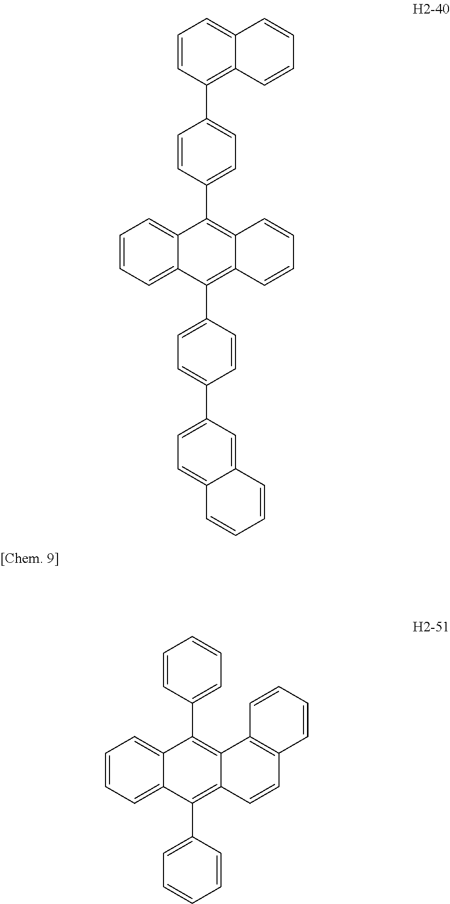

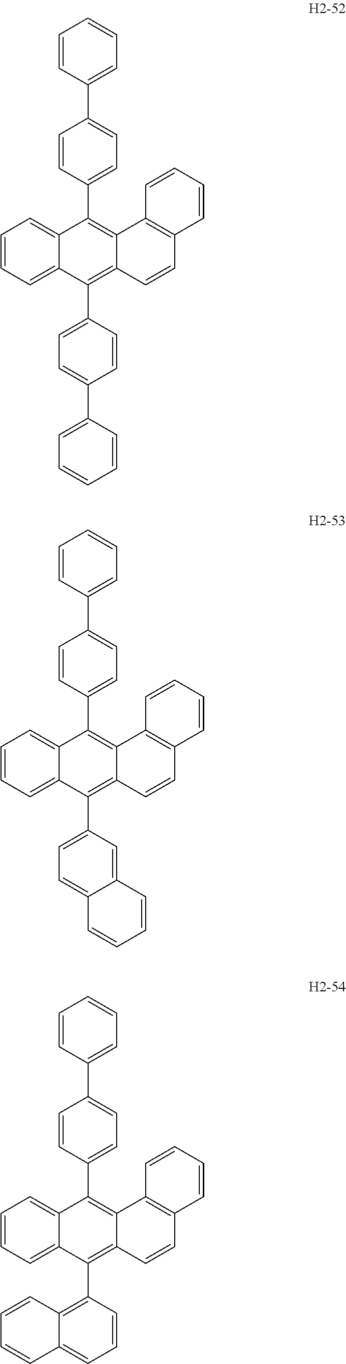

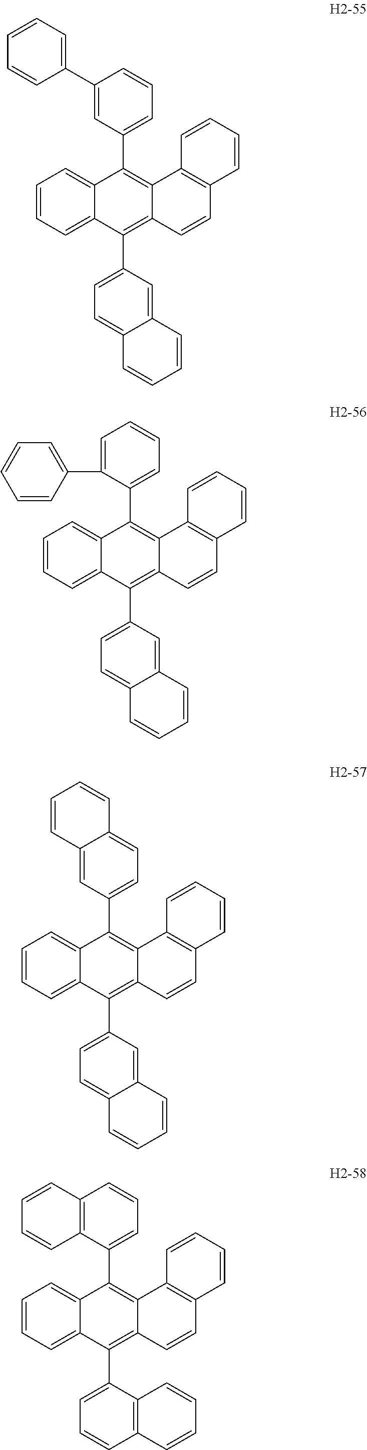

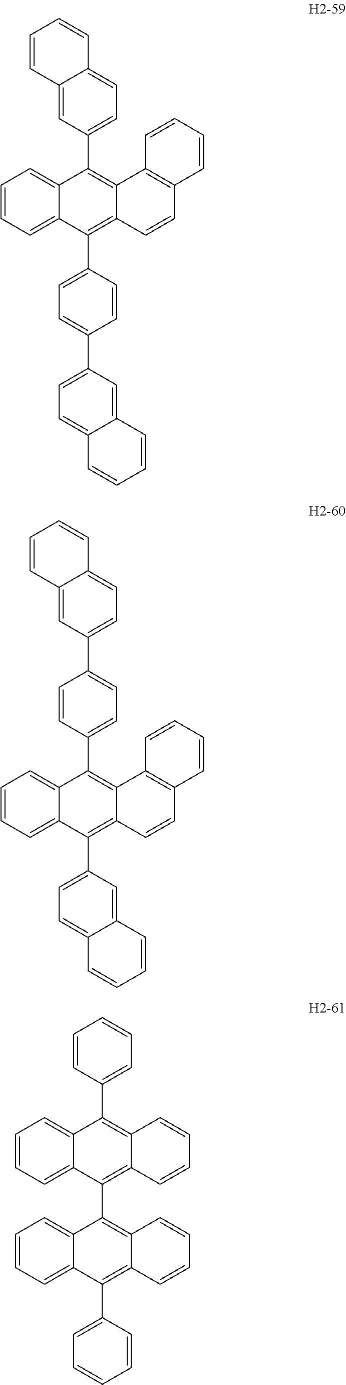

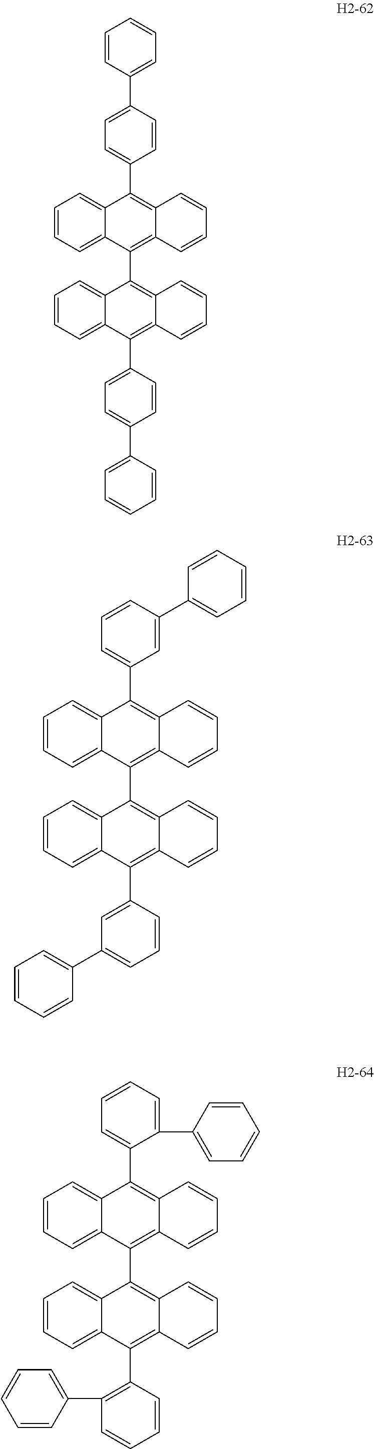

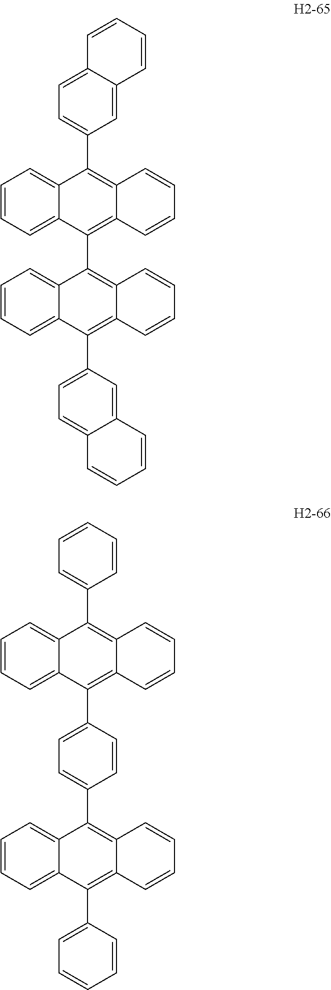

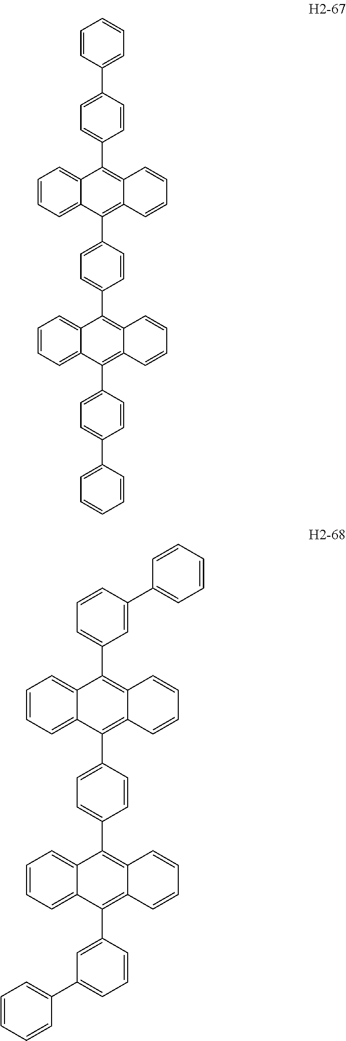

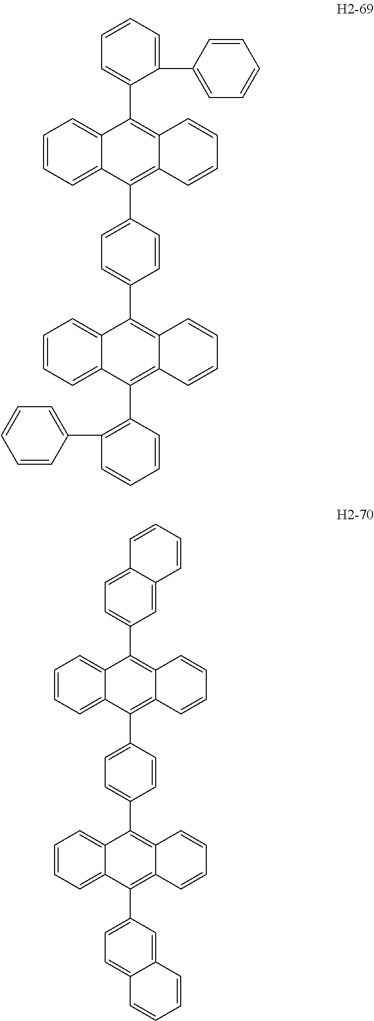

The content (doping amount) of the light emitting material in the light emitting layer 6 containing the light emitting material and the host material is preferably 0.01 to 10 wt %, more preferably 0.1 to 5 wt %. When the content of the light emitting material is adjusted within this range, luminescent efficiency can be optimized.

Also, the average thickness of the light emitting layer 6 is not particularly limited and is preferably about 1 to about 60 nm, more preferably about 3 to about 50 nm.

Electron Transfer Layer

The electron transfer layer 7 is capable of transferring electrons injected through the electron injection layer 8 from the cathode 9 to the light emitting layer 6.

Examples of the material constituting the electron transfer layer 7 (electron transfer material) include phenanthroline derivatives such as 2,9-dimethyl-4,7-diphenyl-1,10-phenanthroline (BCP), 8-quinolinol such as tris(8-quinolinato)aluminum (Alq₃) or quinoline derivatives such as organometallic complexes using a derivative thereof as a ligand, azaindolizine derivatives, oxadiazole derivative, perylene derivatives, pyridine derivatives, pyrimidine derivatives, quinoxaline derivatives, diphenylquinone derivatives, nitro-substituted fluorene derivatives. This material may be used alone or in combination of two or more types.

Of these, as the electron transfer material used for the electron transfer layer 7, an azaindolizine derivative is preferred, and a compound that has an azaindolizine skeleton and an anthracene skeleton in the molecule (hereinafter, simply referred to as an “azaindolizine-based compound”) is more preferred.

As such, since a compound that has an azaindolizine skeleton and an anthracene skeleton is used as the electron transfer material of the electron transfer layer 7 adjacent to the light emitting layer 6, electrons can be efficiently transferred from the electron transfer layer 7 to the light emitting layer 6. For this reason, luminescent efficiency of the light emitting element 1 can be improved.

Also, since electrons can be efficiently transferred from the electron transfer layer 7 to the light emitting layer 6, a driving voltage of the light emitting element 1 can be reduced and, as a result, long lifespan of the light emitting element 1 can be thus realized.

Also, since the compound that has an azaindolizine skeleton and an anthracene skeleton in the molecule exhibits superior stability (resistance) to electrons and holes, long lifespan of the light emitting element 1 can be realized.

In the electron transfer material (azaindolizine-based compound) used for the electron transfer layer 7, the number of the azaindolizine skeletons and anthracene skeletons contained in one molecule is preferably one or two. As a result, an electron transfer property and an electron injection property of the electron transfer layer 7 can be improved.

Specifically, the azaindolizine-based compound used for the electron transfer layer 7 is for example preferably compounds represented by the following formulae ELT-A1 to ELT-A24, compounds represented by the following formulae ELT-B1 to ELT-B12, or compounds represented by the following formulae ELT-C1 to ELT-C20.

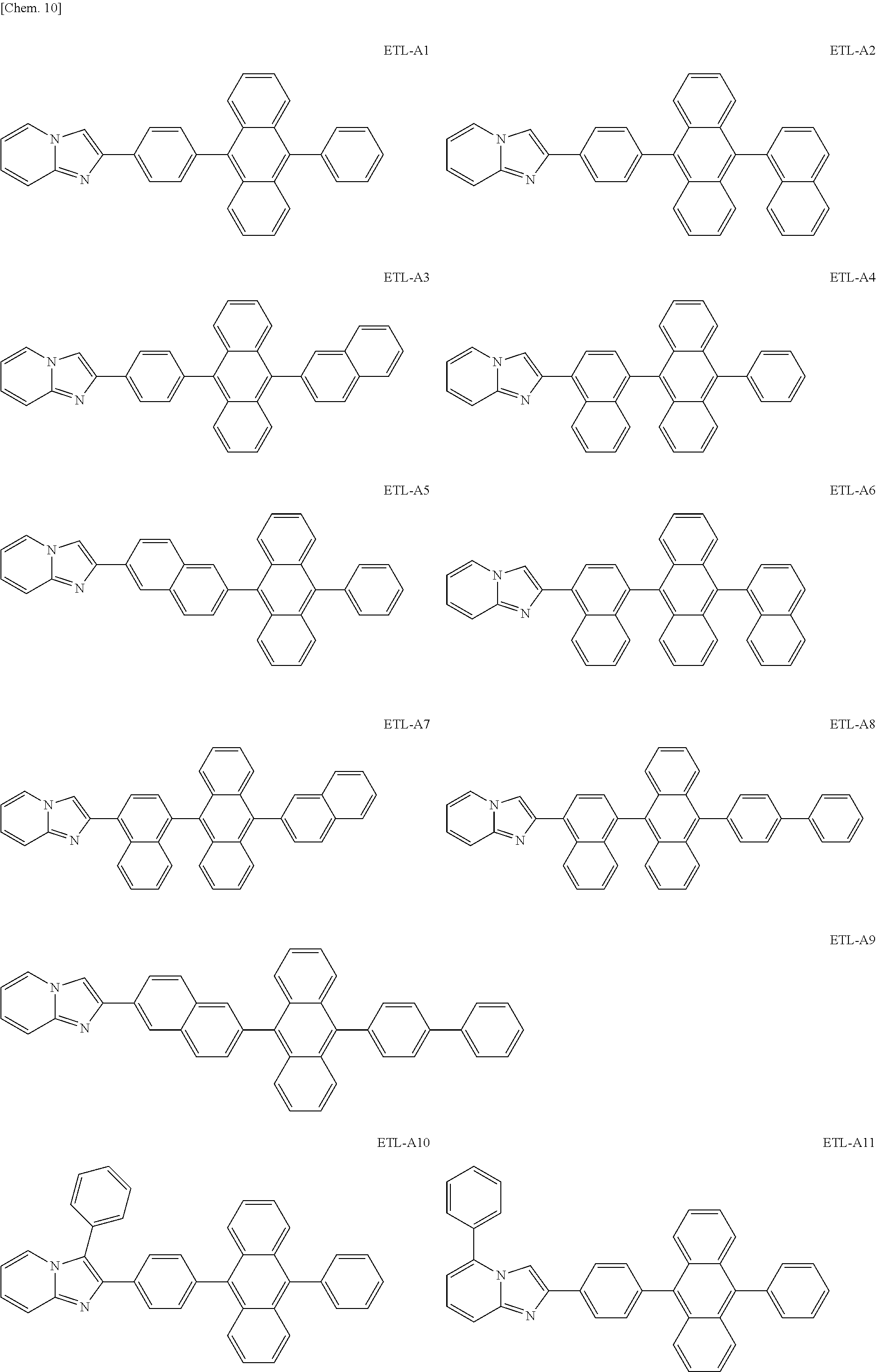

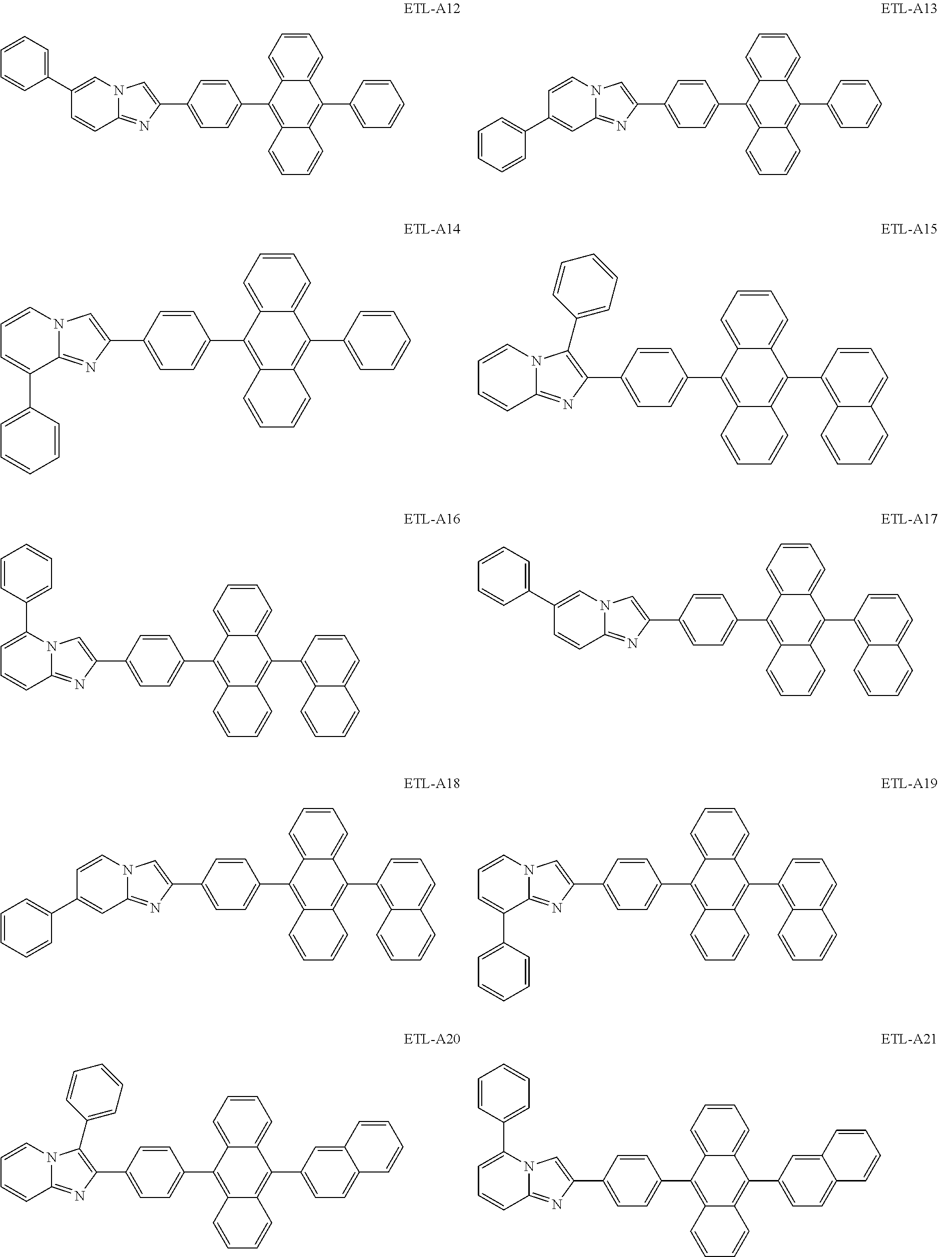

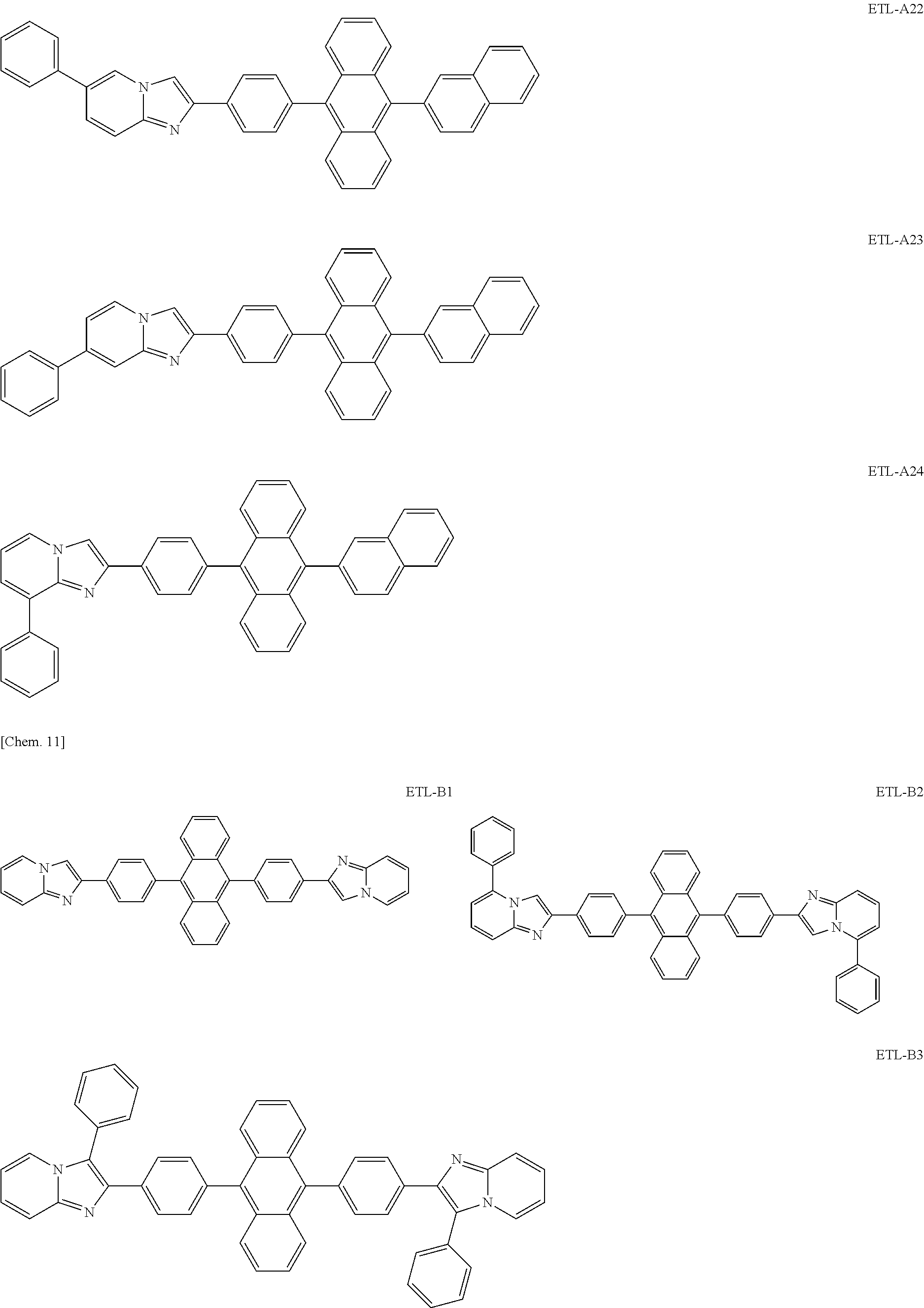

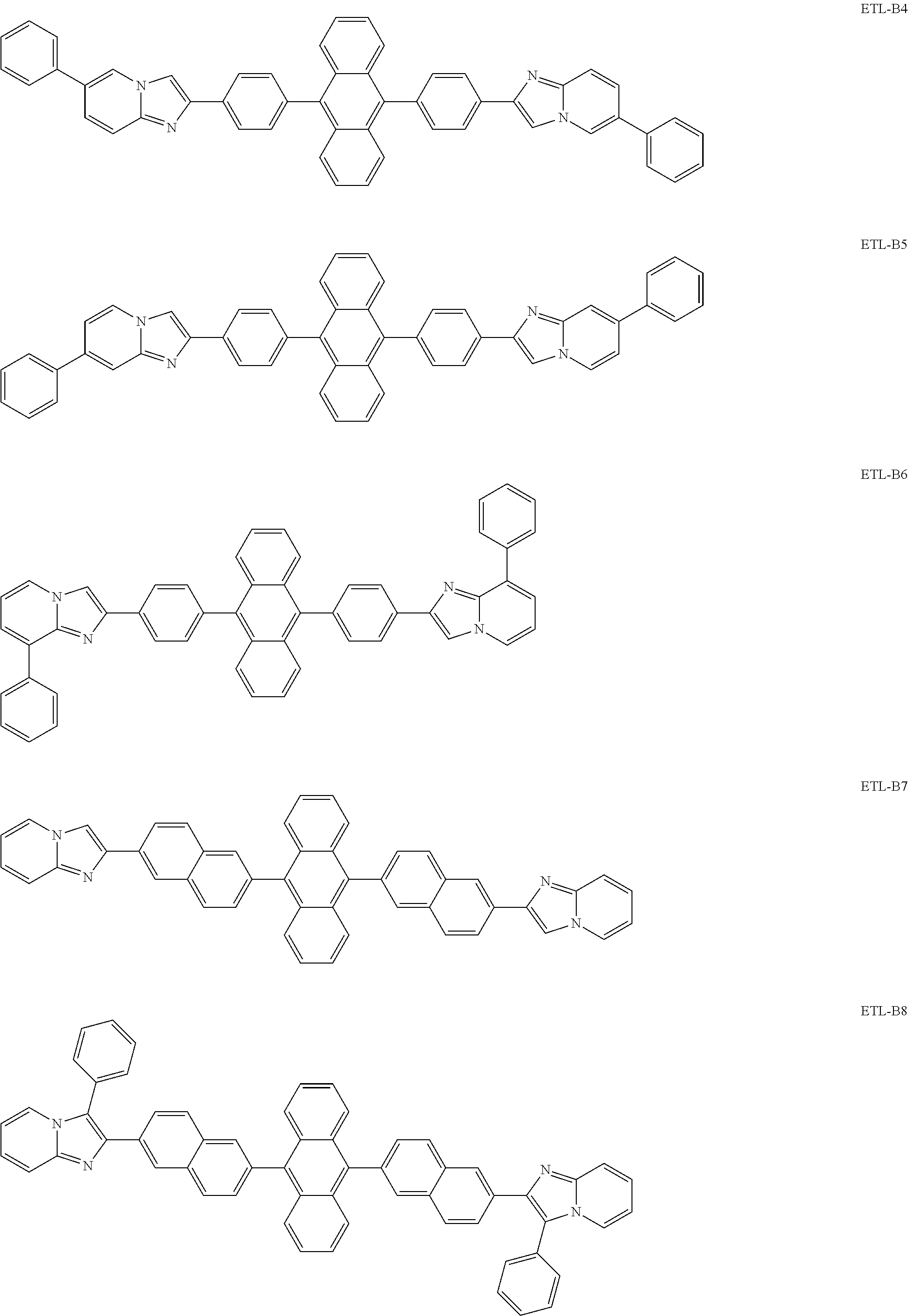

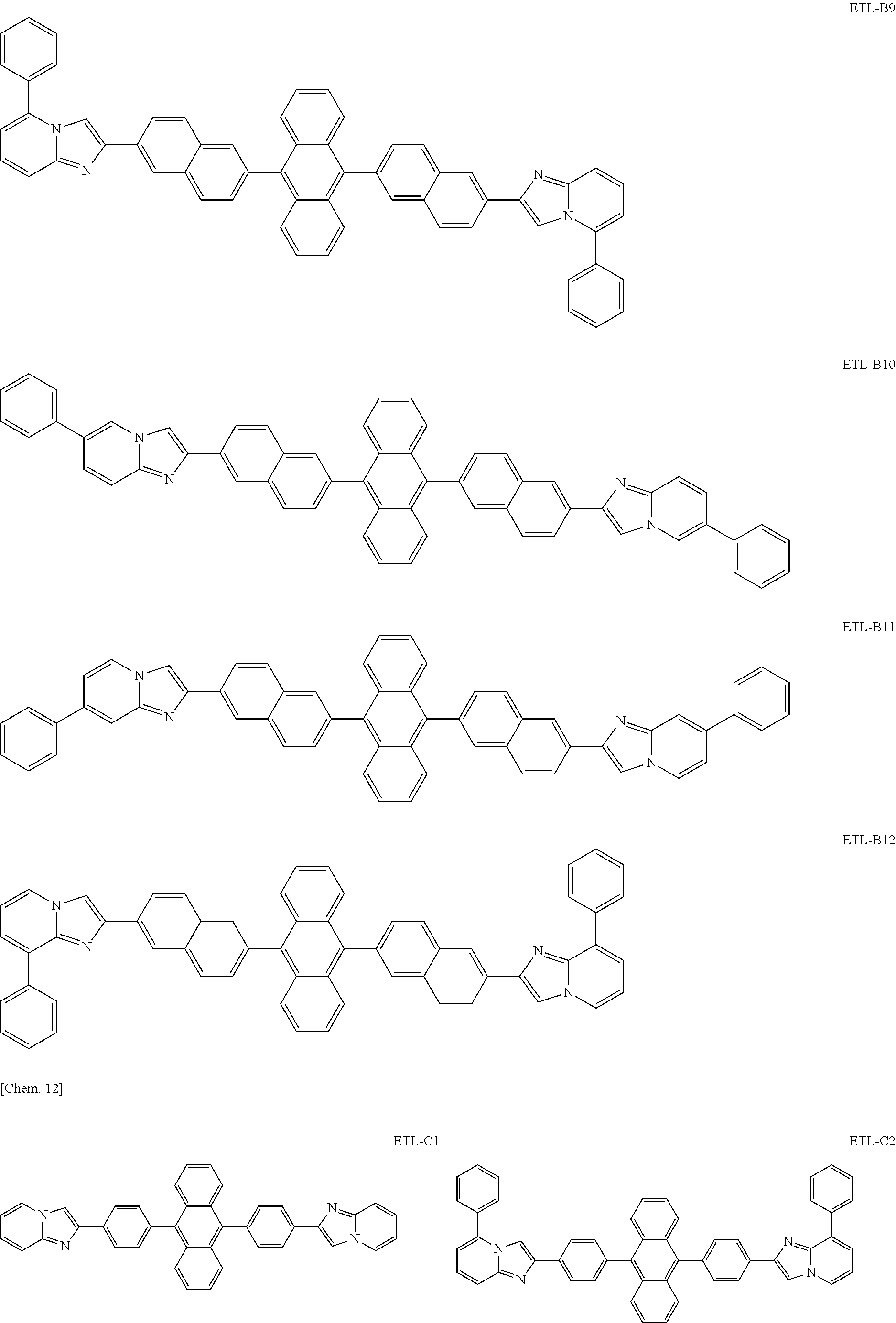

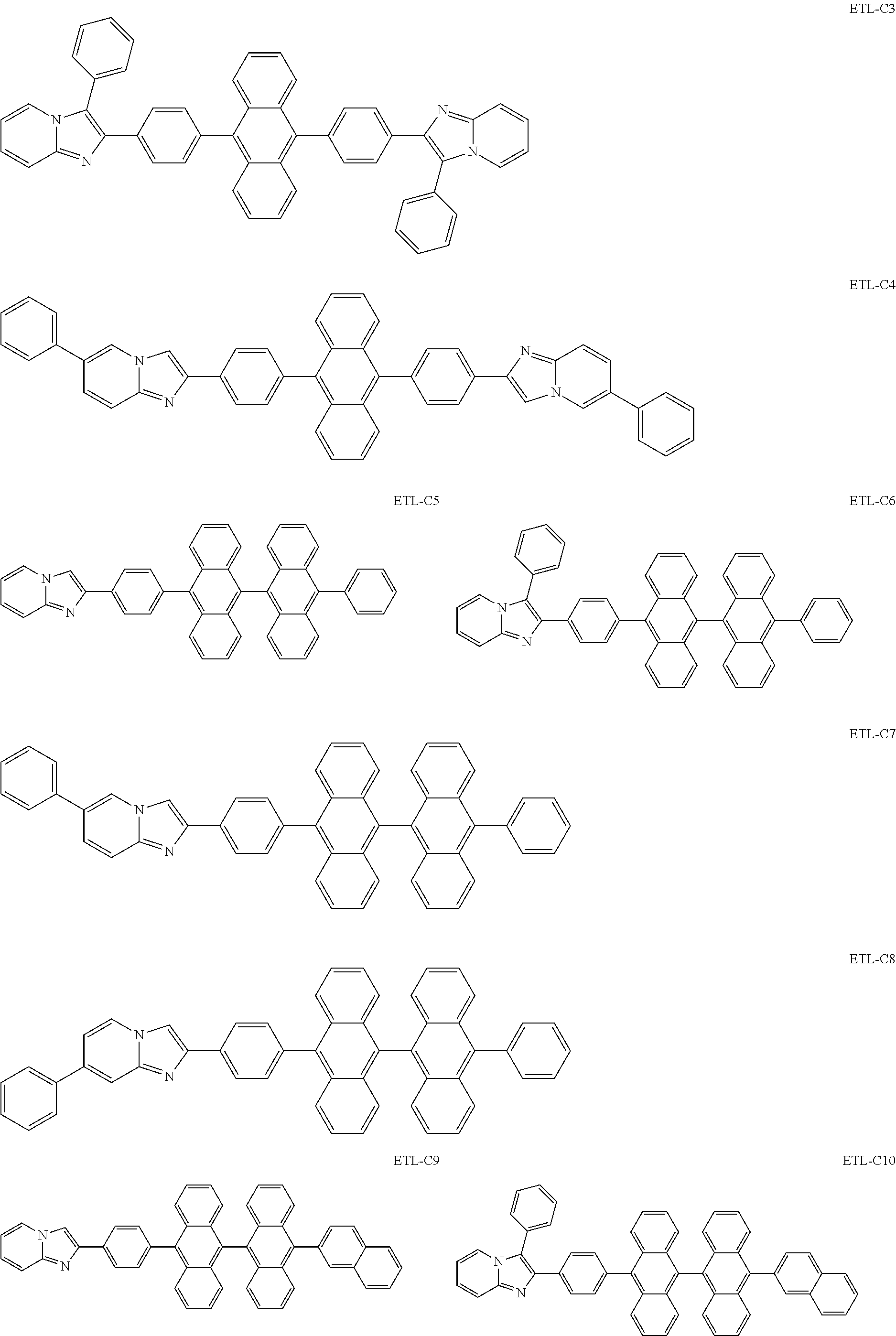

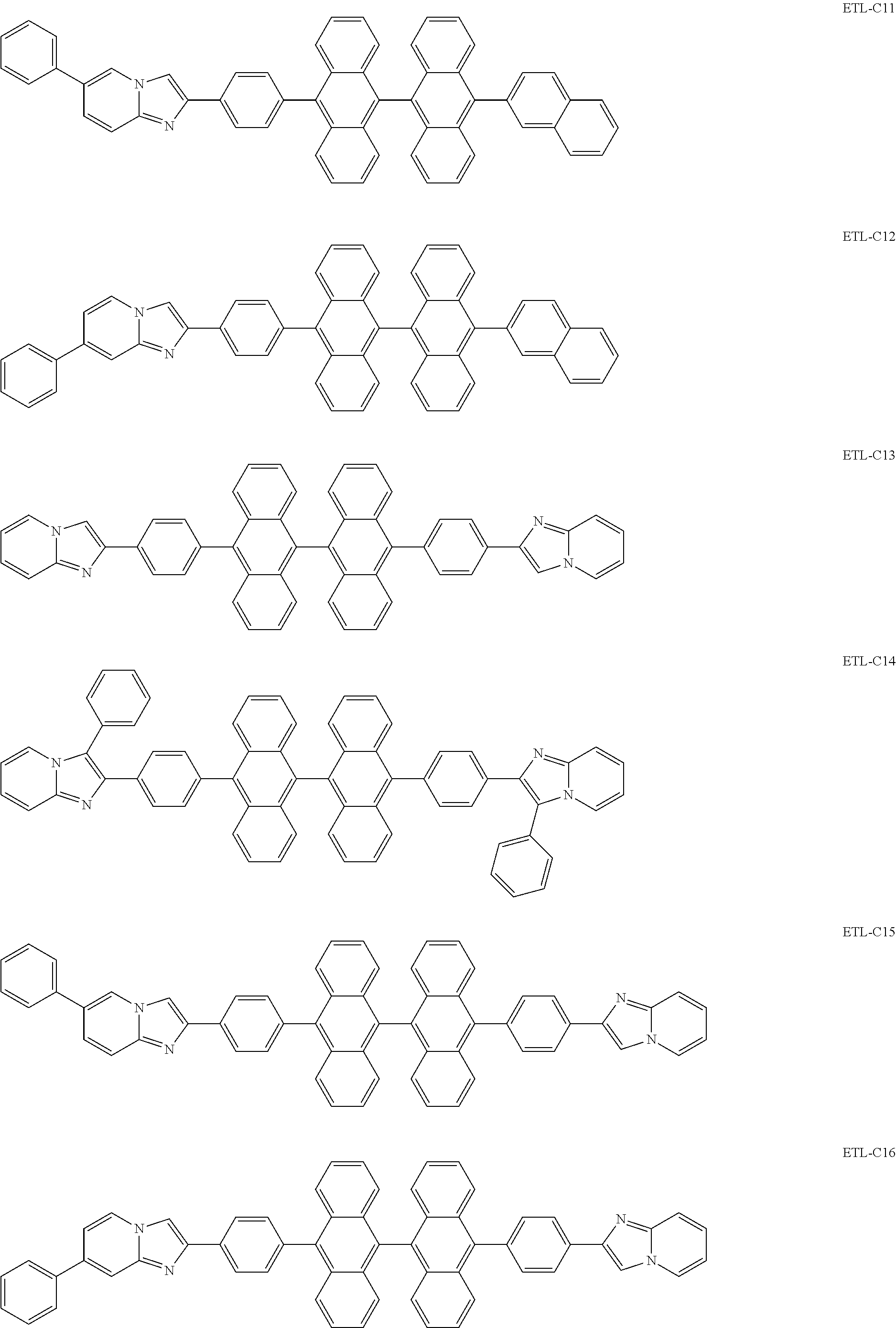

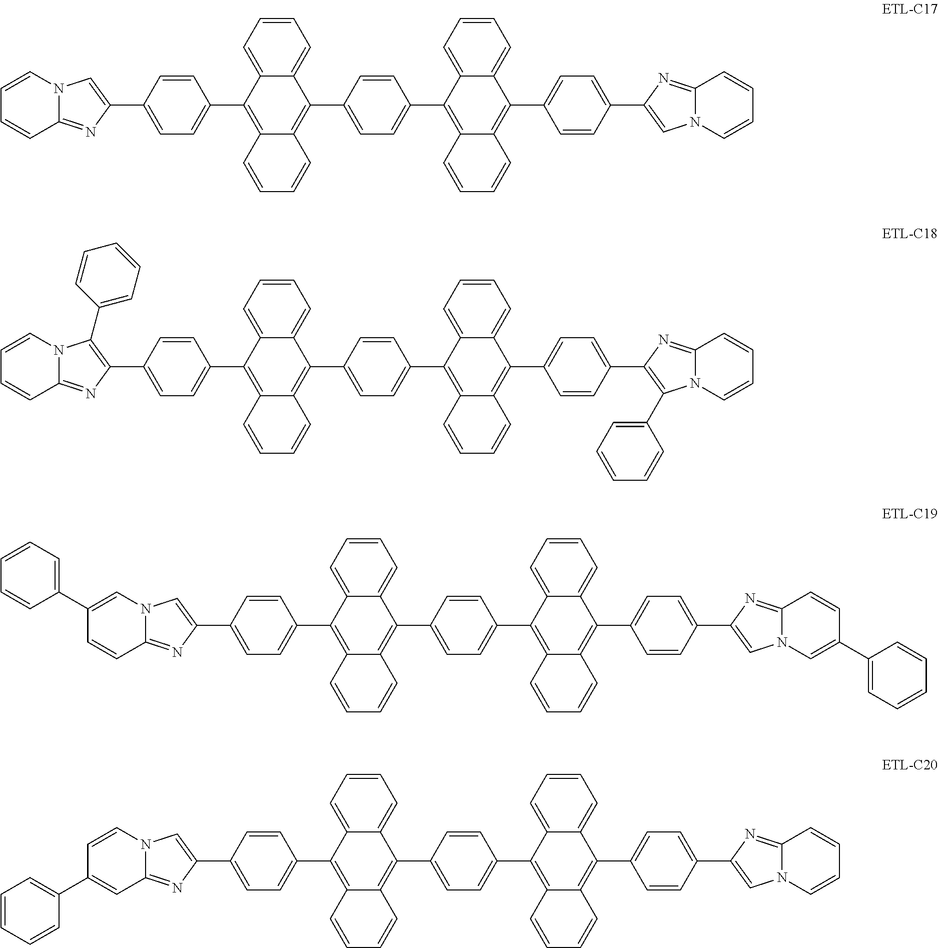

Such an azaindolizine compound exhibits superior electron transfer property and superior electron injection property. For this reason, it is possible to improve luminescent efficiency of the light emitting element 1.

The fact that the azaindolizine compound exhibits a superior electron transfer property and an electron injection property is thought to be due to the following reasons.

Since the aforementioned azaindolizine-based compound having an azaindolizine skeleton and an anthracene skeleton in the molecule has a structure in which the entirety of the molecule is connected through a π conjugation system, the electron cloud widens throughout the molecule.

Also, the azaindolizine skeleton part of the azaindolizine-based compound is capable of receiving electrons and delivering the received electrons to the anthracene azaindolizine skeleton part. Meanwhile, the azaindolizine skeleton part of the azaindolizine-based compound is capable of receiving electrons from the azaindolizine skeleton part and delivering the received electrons to the layer adjacent to the anode 3 of the electron transfer layer 7, that is, the light emitting layer 6.

Specifically, the azaindolizine skeleton part of the azaindolizine-based compound has two nitrogen atoms, the nitrogen atom provided at one side thereof (side near to the anthracene skeleton part) has a sp² hybrid orbital and the nitrogen atom provided at other side thereof (side far from the anthracene skeleton part) has a sp³ hybrid orbital. The nitrogen atom having a sp² hybrid orbital constitutes a part of conjugation system of the molecule of the azaindolizine-based compound, has higher electronegativity than a carbon atom and serves as an electron donor due to strong electron attraction. Meanwhile, since the nitrogen atom having a sp³ hybrid orbital has a non-covalent electron band which is not a common conjugation system, it serves as a part that delivers the electrons to the conjugation system of the molecule of the azaindolizine-based compound.

Meanwhile, since the azaindolizine skeleton part of the azaindolizine-based compound is electrically neutral, it can readily receive electrons from the azaindolizine skeleton part. Also, since the azaindolizine skeleton part of the azaindolizine-based compound has a great orbital overlap with the constituent material of the light emitting layer 6, in particular, the host material (acene-based material), it can easily deliver electrons to the host material of the light emitting layer 6 and receive the electrons therefrom.

Also, such an azaindolizine-based compound, as mentioned above, exhibits superior electron transfer property and superior electron injection property, thus can reduce a driving voltage of the light emitting element 1.

Also, the azaindolizine skeleton part is stable although the nitrogen atom having a sp² hybrid orbital is reduced, or the nitrogen atom having a sp^{a} hybrid orbital is oxidized. For this reason, such an azaindolizine-based compound exhibits superior stability to electrons and holes. As a result, it is possible to realize long lifespan of the light emitting element 1.

Also, when the electron transfer layer 7 uses a combination of two or more of the aforementioned electron transfer materials, it may be a mixed material composed of a combination of two or more of the electron transfer materials, or a laminate including a plurality of layers composed of different electron transfer materials.

The average thickness of the electron transfer layer 7 is not particularly limited and is preferably about 0.5 to about 100 nm, more preferably, about 1 to about 50 nm.

Electron Injection Layer

The electron injection layer 8 is capable of improving electron injection efficiency from the cathode 9.

Examples of the constituent material of the electron injection layer 8 (electron injection material) include a variety of inorganic insulating materials, and a variety of inorganic semiconductor materials.

Examples of the inorganic insulating material include alkali metal chalcogenides (oxides, sulfides, selenides, tellurides), alkaline earth metal chalcogenides, alkali metal halides and alkaline earth metal halides and the like. This material may be used alone or in combination of two or more types. By forming the electron injection layer 8 with this material as a main material, an electron injection property can be further improved. In particular, the alkali metal compound (alkali metal chalcogenides, alkali metal halides and the like) has a low work function. By forming the electron injection layer 8 with the alkali metal compound, the light emitting element 1 can exhibit high brightness.

Examples of the alkali metal chalcogenides include Li₂O, LiO, Na₂S, Na₂Se, NaO and the like.

Examples of the alkaline earth metal chalcogenides include CaO, BaO, SrO, BeO, BaS, MgO, CaSe and the like.

Examples of alkali metal halides include CsF, LiF, NaF, KF, LiCl, KCl, NaCl and the like.

Examples of alkaline earth metal halides include CaF₂, BaF₂, SrF₂, MgF₂, BeF₂ and the like.

Also, examples of the inorganic semiconductor materials include oxides, nitrides and oxynitrides containing at least one element of Li, Na, Ba, Ca, Sr, Yb, Al, Ga, In, Cd, Mg, Si, Ta, Sb and Zn. This material may be used alone or in combination of two or more types.

The average thickness of the electron injection layer 8 is not particularly limited and is preferably about 0.1 to about 1000 nm, more preferably, about 0.2 to about 100 nm, even more preferably about 0.2 to about 50 nm.

In addition, this electron injection layer 8 may be omitted depending on constituent materials or thicknesses of the cathode 9, the electron transfer layer 7 and the like.

Sealing Member

The sealing member 10 is arranged such that it covers the anode 3, the laminate 14 and the cathode 9, air-tightly seals these elements and blocks oxygen or moisture. By mounting the sealing member 10, effects such as improvement of reliability of the light emitting element 1 and prevention of denaturation and deterioration (improvement in durability) can be obtained.

Examples of the constituent material of the sealing member 10 include Al, Au, Cr, Nb, Ta, Ti or alloys containing the same, silicon oxide, various resin materials and the like. In addition, when a conductive material is used as the constituent material of the sealing member 10, an insulating film is preferably provided between the sealing member 10 and the anode 3 and between the laminate 14 and the cathode 9, if necessary, in order to prevent a short circuit.

Also, the sealing member 10 as a flat sheet faces the substrate 2 and may be provided by sealing a space provided therebetween with a sealing material such as a thermosetting resin.

According to the light emitting element 1 having the aforementioned configuration, by using Pt-TPTBP as the light emitting material of the light emitting layer 6 and using the anthracene-based compound as the host material of the light emitting layer 6, emission of a near-infrared region of light is possible and high efficiency and long lifespan can be realized.

By using Pt-TPTBP as the light emitting material of the light emitting layer 6 and using the azaindolizine-based compound as the electron transfer material of the electron transfer layer 7, emission of a near-infrared region of light is possible and high efficiency and long lifespan can be realized.

The aforementioned light emitting element 1 is for example prepared by the following process.

[1] First, a substrate 2 is prepared and an anode 3 is formed on the substrate 2.

The anode 3 may be for example formed using a method such as chemical vacuum deposition (CVD) such as plasma CVD and thermal CVD, dry plating such as vacuum deposition, wet plating such as electrolyte plating, a spraying method, a sol/gel method, an MOD method, and bonding of metal foils.

[2] Then, a hole injection layer 4 is formed on the anode 3.

The hole injection layer 4 is for example preferably formed by a vapor process using a CVD method or a dry plating method such as vacuum deposition and sputtering.

In addition, the hole injection layer 4 may be for example formed by supplying a material for forming a hole injection layer obtained by dissolving a hole injecting material in a solvent or dispersing the same in a dispersion medium, to the anode 3, followed by drying (removal of solvent or removal of dispersion medium).

The method for supplying the material for the hole injection layer is for example one of a variety of application methods such as spin coating; roll coating and inkjet printing. By using this application method, the hole injection layer 4 can be relatively easily formed.

Examples of the solvent or dispersion medium used for preparation of the material for forming the hole injection layer include a variety of inorganic solvents, a variety of organic solvents, and mixed solvents containing the same.

In addition, drying is for example carried out by allowing to stand under an atmospheric pressure or reduced pressure atmosphere, heating, spraying an inert gas or the like.

Also, prior to this process, oxygen plasma treatment may be treated on the upper surface of the anode 3. As a result, imparting lyophilic to the upper surface of the anode 3, removal (washing) of organic materials adhered to the upper surface of the anode 3, control of work function around the upper surface of the anode 3 and the like may be performed.

Here, conditions of oxygen plasma treatment are for example preferably as follows: plasma power of about 100 to about 800 W; oxygen gas flow of about 50 to about 100 mL/min; transfer rate of member to be treated (anode 3) of about 0.5 to about 10 mm/sec; and a temperature of the substrate 2 of about 70 to about 90° C.

[3] Then, a hole transfer layer 5 is formed on the hole injection layer 4.

The hole transfer layer 5 is for example formed by a vapor process using a CVD method or a dry plating method such as vacuum deposition and sputtering.

In addition, the hole transfer layer 5 may be for example formed by supplying a material for forming a hole transfer layer obtained by dissolving a hole-transferring material in a solvent or dispersing the same in a dispersion medium, to the hole injection layer 4, followed by drying (removal of solvent or removal of dispersion medium).

[4] Then, a light emitting layer 6 is formed on the hole transfer layer 5.

The light emitting layer 6 is for example formed by a vapor process using dry plating such as vacuum deposition.

[5] Then, an electron transfer layer 7 is formed on the light emitting layer 6.

The electron transfer layer 7 is for example preferably formed by a vapor process using dry plating such as vacuum deposition.

In addition, the electron transfer layer 7 may be for example formed by supplying a material for forming a electron transfer layer obtained by dissolving a material for an electron transfer material in a solvent or dispersing the same in a dispersion medium, to the light emitting layer 6, followed by drying (removal of solvent or removal of dispersion medium).

[6] Then, an electron injection layer 8 is formed on the electron transfer layer 7.

When an inorganic material is used as a constituent material of the electron injection layer 8, the electron injection layer 8 may be for example formed by a vapor process using a CVD method, or a dry plating method such as vacuum deposition and sputtering, application and baking of inorganic particle ink and the like.

[7] Then, a cathode 9 is formed on the electron injection layer 8.

The cathode 9 may be for example formed using a vacuum deposition method, a sputtering method, bonding of metal foils, application and baking of metal particle ink and the like.

After the aforementioned process, the light emitting element 1 can be obtained.

Finally, the obtained light emitting element 1 is covered with the sealing member 10 and is bonded to the substrate 2.

Light Emitting Device

Then, embodiments of the light emitting device of the invention will be described.

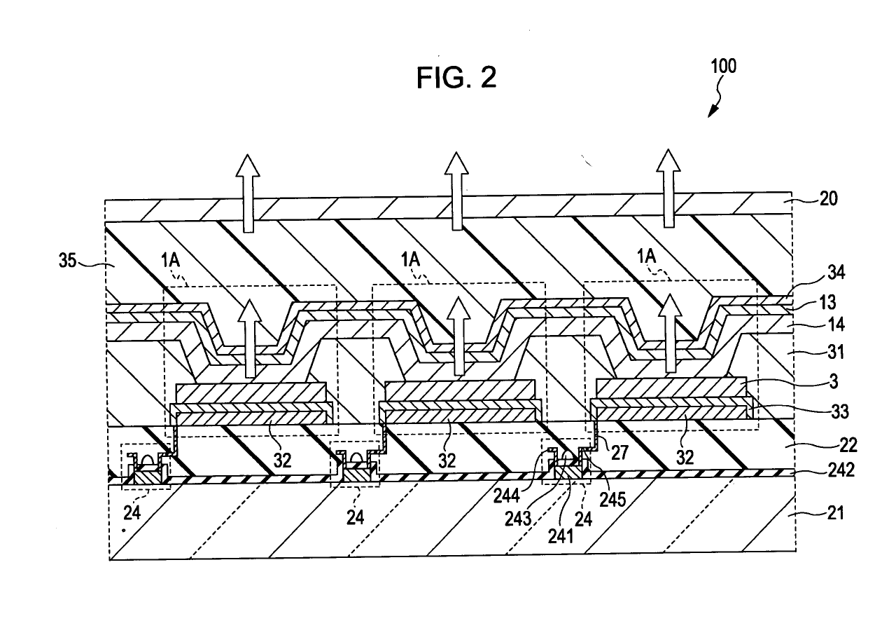

FIG. 2 is a vertical cross-sectional view illustrating an embodiment of a display device using the light emitting device of the invention.

The display device 100 shown in FIG. 2 includes a substrate 21, a plurality of light emitting elements 1A, and a plurality of transistors for driving 24 to drive the respective light emitting elements 1A. Here, the display device 100 is a display panel having a top emission structure.

The transistors for driving 24 are mounted on the substrate 21 and a planarization layer 22 composed of an insulating material is formed such that it covers the transistors for driving 24.

The transistors for driving 24 includes a semiconductor layer 241 composed of silicone, a gate insulating layer 242 formed on the semiconductor layer 241, a gate electrode 243 formed on the gate insulating layer 242, a source electrode 244 and a drain electrode 245.

Light emitting elements 1A corresponding to the respective transistors for driving 24 are mounted on the planarization layer 22.

The light emitting element 1A includes a reflective film 32, an anti-corrosive film 33, an anode 3, a laminate (organic EL light emitting member) 14, a cathode 13 and a cathode cover 34 which are laminated on a planarization layer 22 in this order. In this embodiment, the anode 3 of each light emitting element 1A constitutes a pixel electrode and is electrically connected to the drain electrode 245 of each transistor for driving 24 through a conductive member (line) 27. Also, the cathode 13 of each light emitting element 1A is composed of a common electrode.

In FIG. 2, the light emitting element 1A emits a near-infrared region of light.

A rib barrier 31 is mounted between adjacent light emitting elements 1A. Also, an epoxy layer 35 composed of an epoxy resin is formed on the light emitting element 1A such that it covers the light emitting element 1A.

In addition, a sealing substrate 20 is mounted on the epoxy layer 35 such that it covers the epoxy layer 35.

The display device 100 as described above may be for example used as a near-infrared display for night vision equipment and the like.

The display device 100 can emit a near-infrared region of light. Also, the display device 100 includes a light emitting element 1A with high efficiency and long lifespan, thus exhibits superior reliability.

Authentication Device

Then, embodiments of the authentication device of the invention will be described.

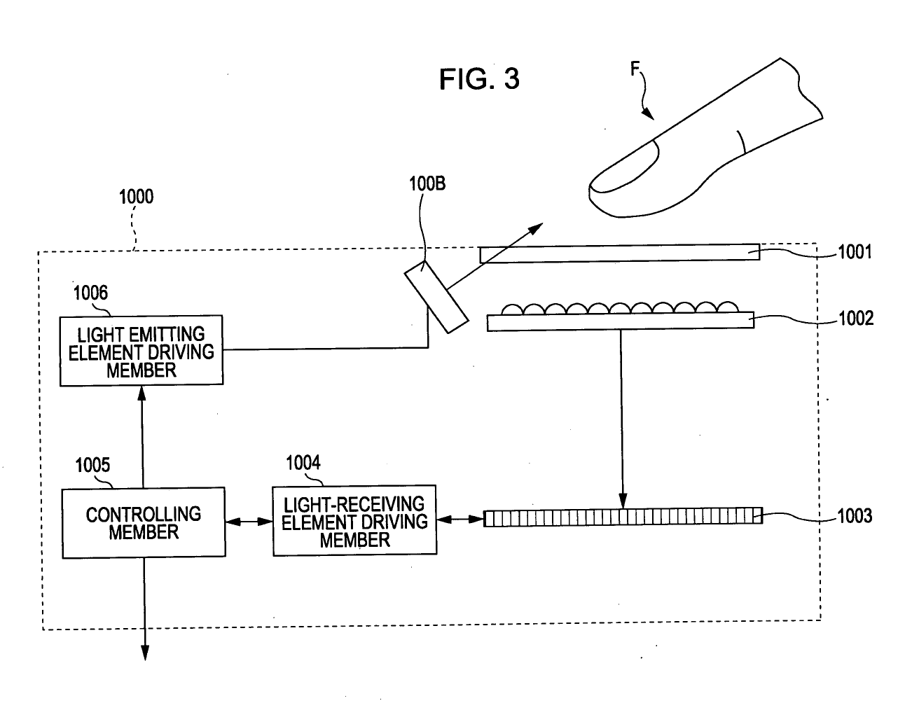

FIG. 3 is a view illustrating an embodiment of the authentication device of the invention.

The authentication device 1000 shown in FIG. 3 is a bio-authentication device that identifies a person using a bio-information of human F (finger tip in this embodiment).

The authentication device 1000 includes a light source 100B, a cover glass 1001, a microlens array 1002, a light-receiving element group 1003, a light emitting element driving member 1006, a light-receiving element driving member 1004 and a controlling member 1005.

The light source 100B includes a plurality of the aforementioned light emitting elements 1 and irradiates a near-infrared region of light to human F, as a subject to be imaged. For example, a plurality of light emitting elements 1 of the light source 100B is arranged along the periphery of the cover glass 1001.

The cover glass 1001 is a part that contacts human F or is adjacent thereto.

The microlens array 1002 is arranged opposite to the side that contacts human F of the cover glass 1001 or is adjacent thereto. The microlens array 1002 includes a plurality of microlenses arranged in a matrix form.

The light-receiving element group 1003 is arranged at the side opposite to the cover glass 1001 with respect to the microlens array 1002. The light-receiving element group 1003 includes a plurality of light-receiving elements arranged in a matrix form corresponding to a plurality of microlenses of the microlens array 1002. Each light-receiving element of the light-receiving element group 1003 is for example a charge coupled device (CCD), complementary metal oxide semiconductor (CMOS) or the like.

The light emitting element driving member 1006 is an driving circuit that drives the light source 100B.

The light-receiving element driving member 1004 is an driving circuit that drives the light-receiving element group 1003.

The controlling member 1005 is for example an micro-processing unit (MPU) and is capable of controlling driving of the light emitting element driving member 1006 and the light-receiving element driving member 1004.

Also, the controlling member 1005 is capable of authenticating human F by comparison between the light-receiving results of the light-receiving element group 1003 and previously stored bio-authentication information.

For example, the controlling member 1005 produces an image pattern (for example vein pattern) of human F based on light-receiving results of the light-receiving element group 1003. In addition, the controlling member 1005 compares the image pattern with a previously stored image pattern as bio-authentication information and identifies (for example, vein authentication) based on the comparison results of human F.

According to the authentication device 1000, bio-authentication can be performed using near-infrared light. Also, the authentication device 1000 includes the light emitting element 1 with high efficiency and long lifespan, thus exhibiting superior reliability.

Such an authentication device 1000 may be mounted on a variety of electronic devices.

Electronic Device

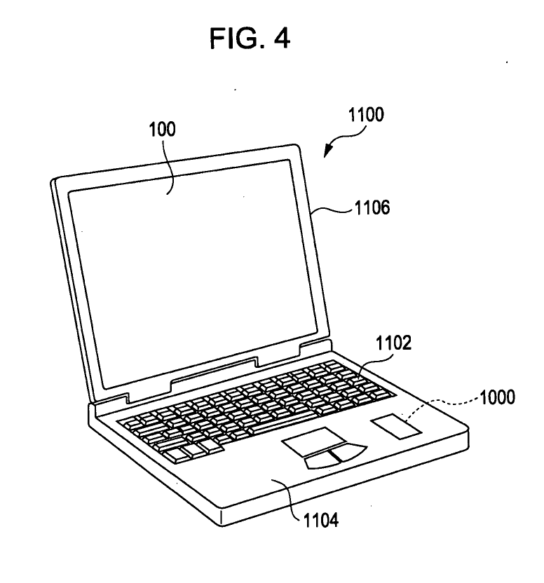

FIG. 4 is a perspective view illustrating the configuration of a mobile-type (or note-type) personal computer using the electronic device according to the invention.

In this drawing, the personal computer 1100 includes a body member 1104 provided with a keyboard 1102, and a display unit 1106 provided with a display member, and the display unit 1106 is rotatably supported by the body member 1104 through a hinge structure.

In the personal computer 1100, the display unit 1106 is provided with the aforementioned display device 100 and the body member 1104 is provided with the aforementioned authentication device 1000.

The personal computer 1100 includes a light emitting element 1 with high efficiency and long lifespan and an authentication device 1000, thus exhibiting superior reliability.

In addition, the electronic device of the invention may be applied to, in addition to the personal computer (mobile-type personal computer) of FIG. 4, for example, mobile telephones, digital still cameras, televisions, video cameras, view finder-type and, monitor direct view-type video tape recorders, lap top-type personal computers, car navigation devices, pagers, electronic notebooks (also including communication function member), electronic dictionaries, calculators, electronic game devices, word processors, work station, television telephones, security television monitors, electronic binoculars, POS terminals, apparatuses with a touch panel (for example, cash dispensers of financial institutions, automated vending machines), medical apparatuses (for example, electronic thermometers, tonometers, blood sugar meters, pulse meters, pulse wave meters, electrocardiogram display devices, ultrasonic diagnosis devices, display devices for endoscopes), fish finders, a variety of measurement apparatuses, instruments (for example, vehicles, aircrafts, ship instruments), flight simulators, other various projection display devices such as monitors, projectors and the like.

Hereinafter, the light emitting element of the invention, the light emitting device, the authentication device and the electronic device have been described based on the embodiments, but the invention is not limited thereto.

### Example

Then, specific embodiments of the invention will be described.

### 1. Preparation of Host Material

### Anthracene-Based Material

### Synthesis Example C1

### Synthesis of Compound Represented by Formula H2-34

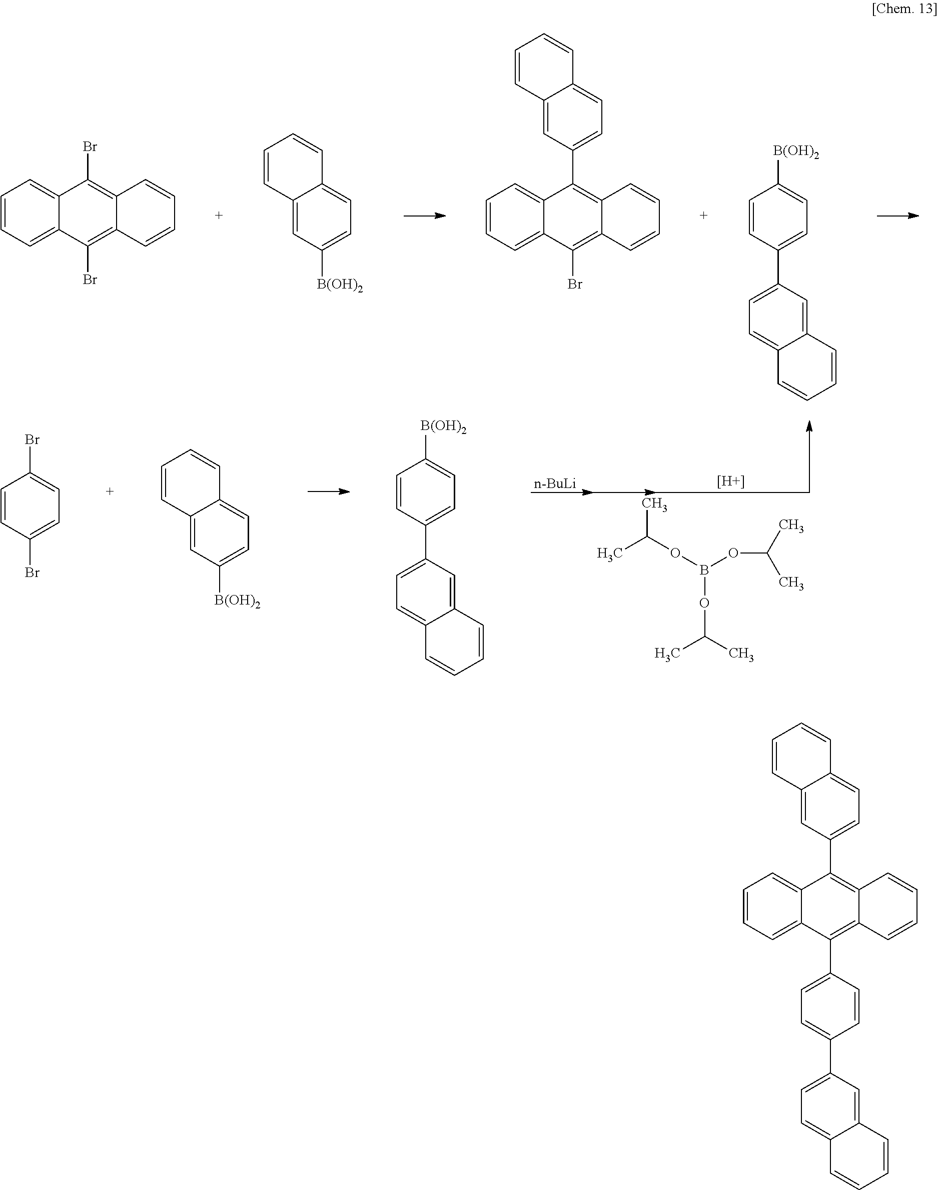

Synthesis (C1-1) 2.1 g of commercially available 2-naphthalene borate and 5 g of 9,10-dibromoanthracene were dissolved in 50 ml of dimethoxyethane, followed by heating to 80° C. 50 ml of distilled water and 10 g of sodium carbonate were added thereto. 0.4 g of tetrakistriphenyl phosphine palladium (0) was further added thereto.

After 3 hours, the reaction solution was extracted in toluene in a seperating funnel and purified by a silica gel (SiO₂ 500 g).

As a result, 3 g of a light yellow white crystal (9-bromo-10-naphthalen-2-yl-anthracene) was obtained.

Synthesis (C1-2) 10.5 g of commercially available 2-naphthalene borate and 17.5 g of 1,4-dibromobenzene were dissolved in 250 ml of dimethoxyethane in a 500 ml flask under Ar, followed by heating to 80° C. 250 ml of distilled water and 30 g of sodium carbonate were added thereto. 2 g of tetrakistriphenyl phosphine palladium (0) was further added thereto.

After 3 hours, the reaction solution was extracted in toluene in a seperating funnel and purified by a silica gel (SiO₂ 500 g).

As a result, 10 g of a white crystal (2-(4-bromo phenyl)-naphthalene) was obtained.

Synthesis (C1-3) 10 g of 2-(4-bromophenyl)-naphthalene obtained in Synthesis (C1-2) and 500 ml of dehydrated tetrahydrofuran were added to a 1 liter flask under Ar and 22 ml of a 1.6M n-BuLi/hexane solution was added dropwise at −60° C. for 30 minutes. After 30 minutes, 7 g of triisopropyl borate was added. After dropwise addition, reaction was performed at a varied temperature over one night. After reaction, 100 ml of water was added dropwise and was extracted with 2 liter of toluene and divided into aliquots. The organic layer was concentrated, recrystallized, filtered and dried to obtain 5 g of a white phenyl borate derivative.

Synthesis (C1-4) 3 g of 9-bromo-10-naphthalen-2-yl-anthracene obtained in Synthesis (C1-1) and 3 g of borate obtained in Synthesis (C1-3) were dissolved under Ar in 200 ml of dimethoxyethane in a 500 ml flask, followed by heating to 80° C. 250 ml of distilled water and 10 g of sodium carbonate were added thereto. 0.5 g of tetrakistriphenyl phosphine palladium (0) was further added thereto.

After 3 hours, the reaction solution was extracted in toluene in a seperating funnel and purified by silica gel chromatography.

As a result, 3 g of a light yellow white solid (the compound represented by formula H2-34) was obtained.

### Synthesis Example C2

### Synthesis of Compound Represented by Formula H2-61

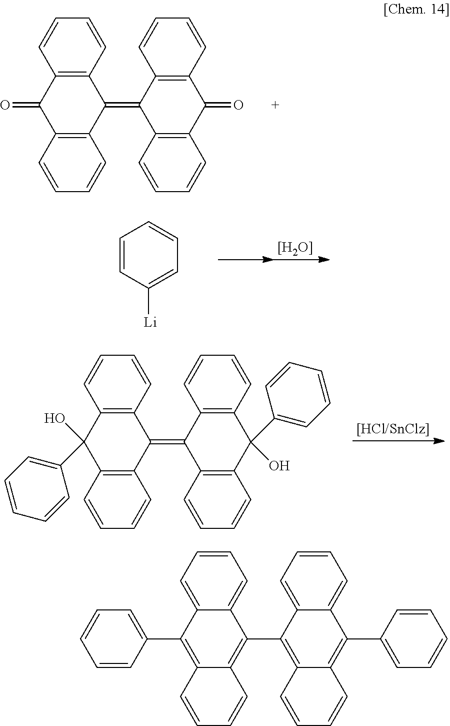

Synthesis (C2-1) 5 g of bianthrone and 150 ml of dried diethyl ether were added to a 300 ml flask under Ar. 5.5 ml of a commercially available phenyl lithium reagent (19% butyl ether solution) was added thereto, followed by stirring for 3 hours at room temperature. Then, 10 ml of water was added thereto, the product was extracted in toluene in a seperating funnel, dried and separated by purification on a silica gel (SiO₂ 500 g).

As a result, 5 g of a white target substance (10,10′-diphenyl-10H,10′H-[9,9′]bianthracenylidene-10,10′-diol) was obtained.

Synthesis (C2-2) 5 g of diol obtained in Synthesis (C2-1) and 300 ml of acetic acid were added to a 500 ml flask. A solution of 5 g of tin (II) chloride (anhydrous) dissolved in 5 g of hydrochloric acid (35%) was added thereto, followed by stirring for 30 minutes. Then, the reaction solution was transferred to a seperating funnel, toluene was added thereto, and the mixture was washed portionwise with distilled water and dried. The obtained solid was purified by a silica gel (SiO₂ 500 g) to obtain 5.5 g of a yellow white solid (the compound represented by formula H2-61).

### Synthesis Example C3

### Synthesis of Compound Represented by Formula H2-66

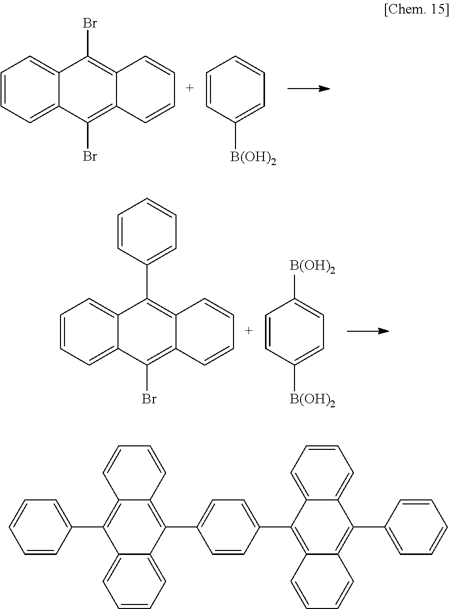

Synthesis (C3-1) 2.2 g of commercially available phenyl borate and 6 g of 9,10-dibromoanthracene were dissolved in 100 ml of dimethoxyethane, followed by heating to 80° C. 50 ml of distilled water and 10 g of sodium carbonate were added thereto. 0.5 g of tetrakistriphenyl phosphine palladium (0) was further added thereto.

After 3 hours, the reaction solution was extracted in toluene in a seperating funnel and purified by a silica gel (SiO₂ 500 g).

As a result, 4 g of a yellow white crystal (9-bromo-10-phenyl-anthracene) was obtained.

Synthesis (C3-2) 4 g of 9-bromo-10-phenyl-anthracene obtained in Synthesis (C3-1) and 0.8 g of a commercial product of phenylene diborate were added under Ar to a 500 ml flask and dissolved in 200 ml of dimethoxyethane, followed by heating to 80° C. 250 ml of distilled water and 10 g of sodium carbonate were added thereto. 0.5 g of tetrakistriphenyl phosphine palladium (0) was further added thereto.

After 3 hours, the reaction solution was extracted in toluene in a seperating funnel and purified by silica gel chromatography.

As a result, 2 g of a light yellow white solid (the compound represented by formula H2-66) was obtained.

### 2. Preparation of Electron Transfer Material

### Azaindolizine-Based Compound

### Synthesis Example D1

### Synthesis of Compound Represented by Formula ETL-A3

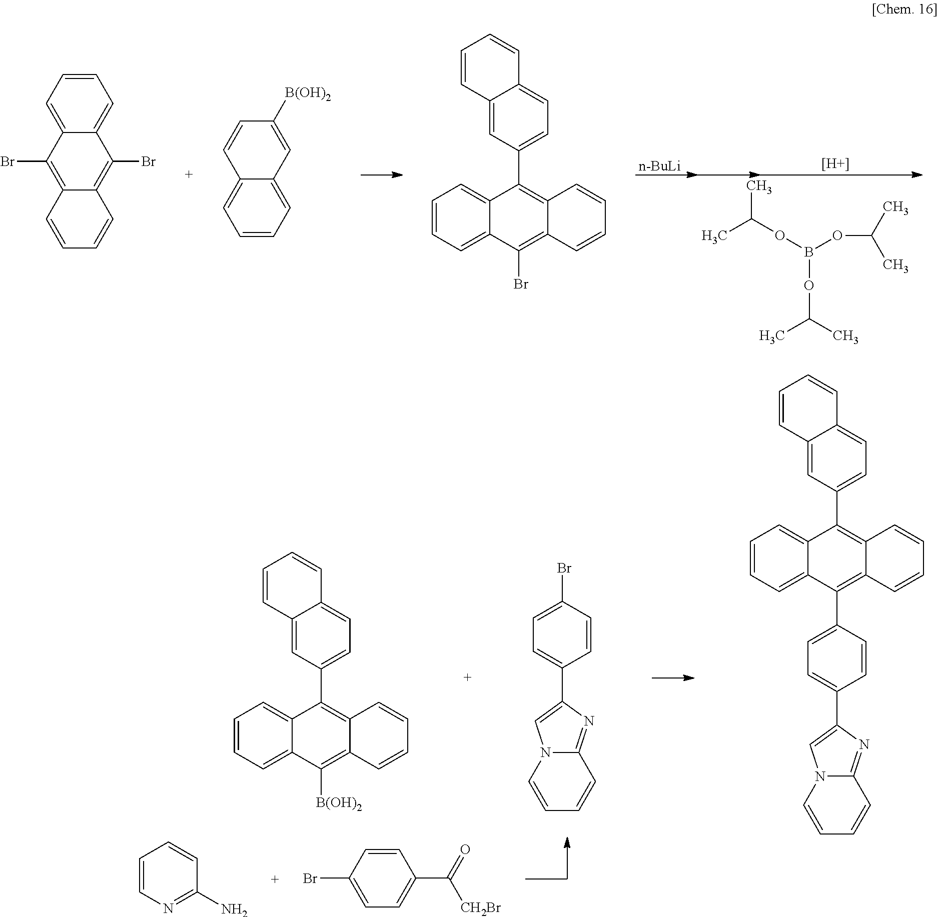

Synthesis (D1-1) 2.1 g of commercially available 2-naphthalene borate and 5 g of 9,10-dibromoanthracene were dissolved in 50 ml of dimethoxyethane, followed by heating to 80° C. 50 ml of distilled water and 10 g of sodium carbonate were added thereto. 0.4 g of tetrakistriphenyl phosphine palladium (0) was further added thereto.

After 3 hours, the reaction solution was extracted in toluene in a seperating funnel and purified by a silica gel (SiO₂ 500 g).

As a result, 3 g of a light yellow white crystal (9-bromo-10-naphthalen-2-yl anthracene) was obtained.

Synthesis (D1-2) 3 g of 9-bromo-10-naphthalene-2-yl-anthracene obtained in Synthesis (D1-1) and 500 ml of dehydrated tetrahydrofuran were added to a 1 liter flask under Ar, and 6 ml of a 1.6M n-BuLi/hexane solution was added dropwise at −60° C. for 10 minutes. After 30 minutes, 1.5 g of triisopropyl borate was added thereto. After dropwise addition, reaction was performed at varied temperatures for 3 hours. After reaction, 50 mL of distilled water was added dropwise, extracted with 1 liter of toluene and divided into aliquots. The organic layer was concentrated, recrystallized, filtered and dried to obtain 2 g of a white target substance (borate).

Synthesis (D1-3) 3.4 g of 2-amino pyridine was weighed to a 300 ml flask under Ar, 40 ml of ethanol and 40 mL of acetone were added thereto and dissolved. 10 g of 4-bromophenacyl bromide was added thereto, followed by refluxing with heating. After 3 hours, the heating was stopped and cooled to room temperature. After the solvent was removed under reduced pressure, the residue was dissolved in 1 liter of methanol under heating, filtered to remove insoluble substances, concentrated, and the resulting precipitate was collected.

As a result, 8 g of the target white solid (2-(4-bromo phenyl)-imidazo[1,2-a]pyridine) was obtained.

Synthesis (D1-4) 2 g of borate obtained in Synthesis (D1-2) and 1.7 g of an imidazopyridine derivative obtained in Synthesis (D1-3) were dissolved in 200 ml of dimethoxyethane in a 500 ml flask under Ar, followed by heating to 80° C. 250 ml of distilled water and 10 g of sodium carbonate were added thereto. 0.5 g of tetrakistriphenyl phosphine palladium (0) was further added thereto.

After 3 hours, the reaction solution was extracted in toluene in a seperating funnel and purified by a silica gel (SiO₂ 500 g).

As a result, 2 g of a white solid (the compound represented by formula ETL-A3) was obtained.

### 3. Production of Light Emitting Element

### Example 1-1

<1> First, a transparent glass substrate with an average thickness of 0.5 mm was prepared. Then, an ITO electrode (anode) with an average thickness of 100 nm was formed on the substrate by a sputtering method.

In addition, the substrate was immersed in acetone and 2-propanol in this order, subjected to ultrasonic cleaning, treated with oxygen plasma and treated with argon plasma. Such plasma treatment was carried out at a plasma power of 100 W, at a gas flow of 20 sccm for a treatment time of 5 sec in a state in which the substrate was heated to 70 to 90° C.

<2> Next, (tetrakis-p-biphenylyl-benzidine) amine-based hole-transferring material was deposited on an ITO electrode by a vacuum deposition method to form a hole transfer layer with an average thickness of 50 nm.

<3> Then, a constituent material for a light emitting layer was deposited on the hole transfer layer by a vacuum deposition method, to form a light emitting layer with an average thickness of 25 nm. With respect to the constituent material for light emitting layer, Pt-TPTBP, the compound represented by formula (IV) was used as a light emitting material (guest material) and a compound represented by Formula H2-34 (anthracene-based material) was used as a host material. Also, the content (doping concentration) of the light emitting material (dopant) in the light emitting layer was 4.0 wt %.

<4> Then, a film was formed using 2,9-dimethyl-4,7-diphenyl-1,10-phenanthroline (BCP) on the light emitting layer by vacuum deposition to form an electron transfer layer with an average thickness of 80 nm.

<5> Then, a film was formed using lithium fluoride (LiF) on the electron transfer layer by a vacuum deposition method to form an electron injection layer with an average thickness of 1 nm.

<6> Then, a film was formed using Al on the electron injection layer by a vacuum deposition method. As a result, a cathode composed of Al with an average thickness of 100 nm was formed.

<7> Then, the formed respective layers were covered with a protective cover (sealing member) made of a glass, fixed with an epoxy resin and sealed.

Through the-aforementioned processes, a light emitting element was produced.

### Example 1-2

A light emitting element was produced in the same manner as in the aforementioned Example 1-1 except that, as a host material of the light emitting layer, the compound represented by formula H2-61 (anthracene-based material) was used.

### Example 1-3

A light emitting element was produced in the same manner as in the aforementioned Example 1-1 except that, as a host material of the light emitting layer, the compound represented by formula H2-66 (anthracene-based material) was used.

### Comparative Example 1-1

A light emitting element was produced in the same manner as in the aforementioned Example 1-1 except that, as a host material of the light emitting layer, Alqₐ was used.

### Example 2-1

A light emitting element was produced in the same manner as in the aforementioned Example 1-1 except that, as a host material of the light emitting layer, tris(8-quinolinorate)aluminum (Alq₃) was used, and the compound (azaindolizine-based compound) represented by Formula ETL-A3 was used as the electron transfer layer.

### Example 2-2

A light emitting element was produced in the same manner as in the aforementioned Example 2-1 except that, as a host material of the light emitting layer, the compound represented by formula H2-34 (anthracene-based material) was used.

### Example 2-3

A light emitting element was produced in the same manner as in the aforementioned Example 2-1 except that, as a host material of the light emitting layer, the compound represented by formula H2-61 (anthracene-based material) was used.

### Example 2-4

A light emitting element was produced in the same manner as in the aforementioned Example 2-1 except that, as a host material of the light emitting layer, the compound represented by formula H2-66 (anthracene-based material) was used.

### Example 2-5

A light emitting element was produced in the same manner as in the aforementioned Example 2-1 except that the average thickness of the light emitting layer was 45 nm and the average thickness of the electron transfer layer was 60 nm.

### Example 2-6

A light emitting element was produced in the same manner as in the aforementioned Example 2-1 except that the average thickness of the light emitting layer was 15 nm and the average thickness of the electron transfer layer was 90 nm.

### Example 2-7

A light emitting element was produced in the same manner as in the aforementioned Example 2-1 except that the electron transfer layer was formed by laminating Alq₃ and the compound represented by formula ETL-A3 in this order by vacuum deposition.

Here, with respect to the electron transfer layer, the average thickness of the layer comprising Alq₃ was 20 nm and the average thickness of the layer comprising ETL-A3 was 60 nm.

### Comparative Example 2-1

A light emitting element was produced in the same manner as in the aforementioned Example 2-1 except that 2,9-dimethyl-4,7-diphenyl-1,10-phenanthroline (BCP) was used as an electron transfer material of the electron transfer layer, the average thickness of the light-emitting layer was 45 nm, and the average thickness of the electron transfer layer was 60 nm.

### Comparative Example 2-2

A light emitting element was produced in the same manner as in the aforementioned Example 2-1 except that 2,9-dimethyl-4,7-diphenyl-1,10-phenanthroline (BCP) was used as an electron transfer material of the electron transfer layer, the average thickness of the light-emitting layer was 15 nm, and the average thickness of the electron transfer layer was 90 nm.

### Comparative Example 2-3

A light emitting element was produced in the same manner as in the aforementioned Example 2-1 except that the electron transfer layer was formed by laminating Alq₃ and BCP in this order by vacuum deposition.

Here, with respect to the electron transfer layer, the average thickness of the layer comprising Alq₃ was 20 nm and the average thickness of the layer comprising BCP was 60 nm.

### Comparative Example 2-4

A light emitting element was produced in the same manner as in the aforementioned Example 2-1 except that Alqₐ was used as an electron transfer material of the electron transfer layer.

### 4. Evaluation

With respect to Examples and Comparative Examples, a constant current of 100 mA/cm² was applied to a light emitting element using a constant current power (KEITHLEY 2400, produced by TOYO TECHNICAL Co., Ltd.), and the light-emitting peak wavelength and light-emitting power were measured using a spectroradiometer (CS-2000, produced by Konica Minolta Sensing, Inc.). Also, light power meter 8230, produced by ADC Corp. was used for the measurement of the light-emitting power.

Also, at this time, a voltage value (driving voltage) was measured.

Also, with respect to Examples 1-1 to 1-3, a time (LT70) at which brightness became 80% of the initial brightness was measured.

Also, with respect to Examples 2-1 to 2-7 and Comparative Examples 2-1 to 2-4, a time (LT80) at which brightness became 80% of the initial brightness was measured.

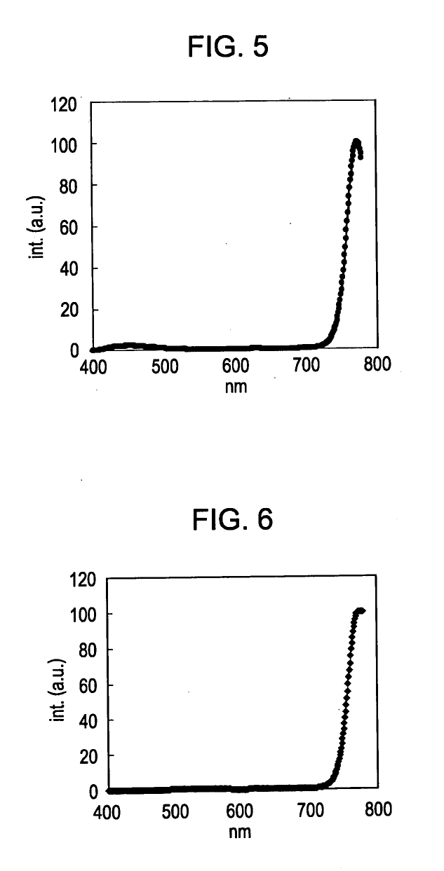

These measurement results are shown in Tables 1 and 2. Also, the luminescent spectrum of the light emitting device in Example 1-1 is shown in FIG. 5 and the luminescent spectrum of the light emitting device in Comparative Example 1-1 is shown in FIG. 6.

TABLE 1

| | Light-emitting layer | | | | Electron | | | | | |
|---|---|---|---|---|---|---|---|---|---|---|
| | | | Concentration | | transfer layer | | Evaluation | | | |
| | | | of light-emitting | Average | | Average | Light-emitting | light-emitting | | |
| | Light-emitting | Host | material | thickness | | thickness | peak wavelength | power | Voltage | LT70 |
| | material | material | [w %] | [nm] | Material | [nm] | [nm] | [mW/cm²] | [V] | [hr] |
| Example 1-1 | PtTPTBP | H2-34 | 4 | 25 | BCP | 80 | 770 | 1.0 | 7.4 | >500 |
| Example 1-2 | PtTPTBP | H2-61 | 4 | 25 | BCP | 80 | 770 | 0.9 | 7.3 | >500 |
| Example 1-3 | PtTPTBP | H2-66 | 4 | 25 | BCP | 80 | 770 | 0.9 | 7.4 | >500 |
| Comparative | PtTPTBP | Alq | 4 | 25 | BCP | 80 | 775 | 0.8 | 7.8 | <30 |
| Example 1-1 | | | | | | | | | | |

TABLE 2

| | Light-emitting layer | | | | Electron | | | | | |
|---|---|---|---|---|---|---|---|---|---|---|
| | | | Concentration | | transfer layer | | Evaluation | | | |
| | | | of light-emitting | Average | | Average | Light-emitting | Light-emitting | | |
| | Light-emitting | Host | material | thickness | | thickness | peak wavelength | power | Voltage | LT80 |
| | material | material | [w %] | [nm] | Material | [nm] | [nm] | [mW/cm²] | [V] | [hr] |
| Example 2-1 | PtTPTBP | Alq | 4 | 25 | ETL-A3 | 80 | 780 | 1.7 | 6.4 | >1000 |
| Example 2-2 | PtTPTBP | H2-34 | 4 | 25 | ETL-A3 | 80 | 770 | 0.9 | 7.4 | 600 |
| Example 2-3 | PtTPTBP | H2-61 | 4 | 25 | ETL-A3 | 80 | 770 | 0.7 | 6 | 700 |
| Example 2-4 | PtTPTBP | H2-66 | 4 | 25 | ETL-A3 | 80 | 770 | 0.7 | 6 | 700 |
| Example 2-5 | PtTPTBP | Alq | 4 | 45 | ETL-A3 | 60 | 770 | 1.6 | 6.6 | >1000 |
| Example 2-6 | PtTPTBP | Alq | 4 | 15 | ETL-A3 | 90 | 770 | 1.7 | 6.3 | >1000 |
| Example 2-7 | PtTPTBP | Alq | 4 | 25 | Alq | 20 | 770 | 1.5 | 6.4 | >1000 |
| | | | | | ETL-A3 | 60 | | | | |
| Comparative | PtTPTBP | Alq | 4 | 45 | BCP | 60 | 770 | 1.4 | 9.5 | <30 |
| Example 2-1 | | | | | | | | | | |
| Comparative | PtTPTBP | Alq | 4 | 15 | BCP | 90 | 770 | 1.4 | 10 | <30 |
| Example 2-2 | | | | | | | | | | |
| Comparative | PtTPTBP | Alq | 4 | 25 | Alq | 20 | 770 | 1.3 | 9.4 | <30 |
| Example 2-3 | | | | | BCP | 60 | | | | |
| Comparative | PtTPTBP | Alq | 4 | 25 | Alq | 80 | 770 | 1.3 | 8.5 | <30 |
| Example 2-4 | | | | | | | | | | |

As apparent from Table 1 above, the light emitting elements of Examples 1-1 to 1-3 emit light in a near-infrared region and exhibit superior light-emitting power as compared to the light emitting element of Comparative Example 1-1. In addition, the light emitting elements of Examples 1-1 to 1-3 can inhibit a driving voltage, as compared to the light emitting element of Comparative Example 1-1. In this regard, the light emitting elements of Examples 1-1 to 1-3 exhibit superior light-emitting efficiency.

In addition, the light emitting elements of Examples 1-1 to 1-3 have long lifespan, as compared to the light emitting element of Comparative Example 1-1.

As apparent from Table 2, the light emitting elements of Examples 2-1 to 2-7 emit light in a near-infrared region and exhibit superior light-emitting power as compared to the light emitting elements of Comparative Examples 2-1 to 2-4. In addition, the light emitting elements of Examples 2-1 to 2-7 can inhibit an driving voltage, as compared to the light emitting elements of Comparative Examples 2-1 to 2-4. In this regard, the light emitting elements of Examples 2-1 to 2-7 exhibit superior light-emitting efficiency.

In addition, the light emitting elements of Examples 2-1 to 2-7 have long lifespan, as compared to the light emitting elements of Comparative Examples 2-1 to 2-4.

This application claims the benefit of Japanese Patent Application No. 2011-092745, filed on Apr. 19, 2011, which is hereby incorporated by reference as if fully set forth herein.

1. A light emitting element comprising:
an anode;
a cathode; and
a light emitting layer that is interposed between the anode and the cathode and emits light through electric connection between the anode and the cathode,
wherein the light-emitting layer contains a light-emitting material and a host material, the host material is at least one selected from organic substances having a basic skeleton represented by formulae (I) to (III), and the light-emitting material is a compound represented by formula (IV), 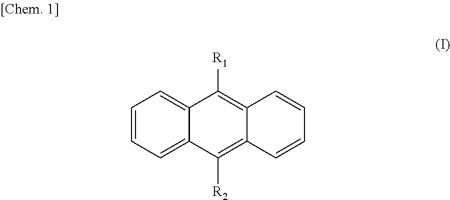
In formula (I), wherein R₁ and R₂ are identical to or different from each other independently represent an alkyl group, a substituted or unsubstituted aryl group, an amino group or a heterocyclic group, 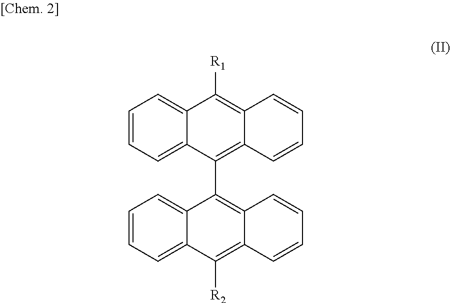
In formula (II), wherein R₁ and R₂ are identical to or different from each other independently represent an alkyl group, a substituted or unsubstituted aryl group, an amino group or a heterocyclic group, 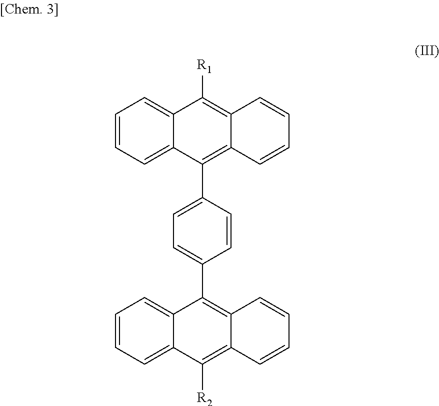
In formula (III), R₁ and R₂ are identical to or different from each other independently represent an alkyl group, a substituted or unsubstituted aryl group, an amino group or a heterocyclic group, 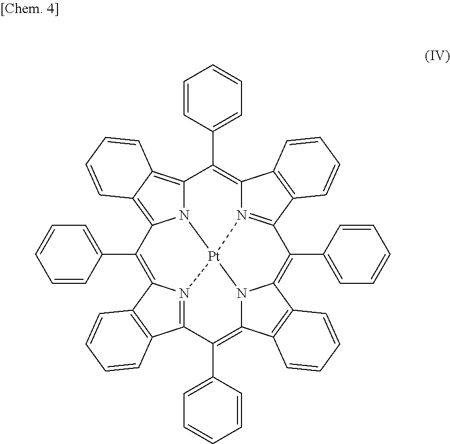
wherein formula (IV) represents Pt (II) tetraphenyl-tetrabenzo-porphyrin.

2. The light emitting element according to claim 1, wherein the content of the host material is 80 to 99% by mass.

3. The light emitting element according to claim 1, wherein the light emitting element comprises a hole injection transfer layer provided between the anode and the light emitting layer.

4. The light emitting element according to claim 1, wherein the light emitting element comprises an electron injection transfer layer provided between the cathode and the light emitting layer.

5. The light emitting element according to claim 1, further comprising an electron transfer layer having electron transfer property, provided between the cathode and the light emitting layer such that the electron transfer layer contacts the light emitting layer,
wherein the electron transfer layer comprises a compound having an azaindolizine skeleton and an anthracene skeleton in the molecule, as an electron transfer material.

6. A light emitting element comprising:
an anode;
a cathode;
a light emitting layer that is interposed between the anode and the cathode and emits light through electric connection between the anode and the cathode,
an electron transfer layer having electron transfer property, provided between the cathode and the light emitting layer such that the electron transfer layer contacts the light emitting layer,
wherein the light-emitting layer contains a light emitting material and a host material, the light emitting material comprises a compound represented by the following formula (IV) as a light emitting material, and the electron transfer layer contains a compound having azaindolizine skeletons and anthracene skeletons in the molecule as an electron transfer material, 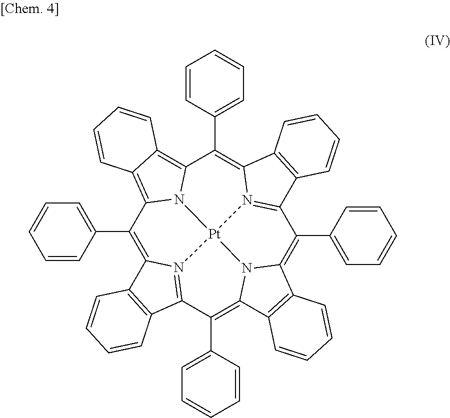
wherein formula (IV) represents Pt (II) tetraphenyl-tetrabenzo-porphyrin.

7. The light emitting element according to claim 6, wherein the respective numbers of azaindolizine skeletons and anthracene skeletons contained in one molecule of the electron transfer material are one or two.

8. The light emitting element according to claim 6, wherein the host material comprises a quinolinolate-based metal complex.

9. A light emitting device comprising the light emitting element according to claim 1.

10. An authentication device comprising the light emitting element according to claim 1.

11. An electronic device comprising the light emitting element according to claim 1.

12. A light emitting device comprising the light emitting element according to claim 6.

13. An authentication device comprising the light emitting element according to claim 6.

14. An electronic device comprising the light emitting element according to claim 6.
